(19) United States
(12) Patent Application Publication
(10) Pub. No.: US 2003/0215955 A1
(43) Pub. Date: Nov. 20, 2003

(54) System and method to test nutritional supplements

(76) Inventor: Jacky F. Dunn, Russellville, AR (US)

Correspondence Address: Susan B. Fentress, Butler, Snow, O'Mara, Stevens & Cannada, PLLC., P.O. Box 141443, Memphis, TN, 38187-1443, US

(21) Appl. No.: 10/434,137

(22) Filed: May 8, 2003

Related U.S. Application Data
(60) Provisional application No. 60/378,982, filed on May 9, 2002.

(51) Int. Cl. G01N 1/00

(52) U.S. Cl. 436/174

(57) ABSTRACT

This invention provides a fluid sample retrieval kit, including a sample transfer tube, to facilitate a method of confidentially providing laboratory test results to a consumer of the fluid sample retrieval kit. Additionally, this invention provides a method to compare clinical chemistry values from a plurality of consumers for a designated nutritional supplement, or a combination of nutritional supplements. Additionally, this method provides a fluid sample retrieval system.

### RELATED APPLICATIONS

THIS APPLICATION CLAIMS THE PRIORITY DATE OF U.S. PROVISIONAL APPLICATION FILED MAY 9, 2002, U.S. SERIAL NO. 60/378,982 UNDER 35 U.S.C. § 119(e) HEREBY SPECIFICALLY INCORPORATED BY REFERENCE.

### STATEMENT REGARDING FEDERALLY SPONSORED RESEARCH OR DEVELOPMENT

NOT APPLICABLE

### REFERENCE TO A “MICROFICHE APPENDIX”

NOT APPLICABLE

### FIELD OF THE INVENTION

The present invention is related to a system and method to test nutritional supplements.

### BACKGROUND OF THE INVENTION

Nutritional supplements are used by consumers to enhance performance or to improve general health. These supplements vary from one manufacturer to another. It would be advantageous to provide a way for a particular manufacturer to establish the effectiveness of a particular nutritional supplement through testing of a large number of individuals.

### DESCRIPTION OF THE RELATED ART

More than one half of the U.S. adult population uses dietary supplements. In 1996 alone, consumers spent more than $6.5 billion on dietary supplements. In 1994 Congress enacted the Dietary Supplement Health Education Act (“DSHEA”) to provide for FDA regulation of dietary supplements. The law essentially gives dietary supplement manufacturers freedom to market more products as dietary supplements and provide information about their products' benefits. Data collected for numerous users of a nutritional supplement could be used to show that a nutritional supplement is safe.

Moreover, claims that tout a supplement's healthful benefit have been a controversial feature of dietary supplements. Manufacturers often rely on them to sell their products, but consumers often wonder whether they can trust the manufacturer's assertions. Under DSHEA supplement manufacturers are allowed to use three types of claims: nutrient-content claims, disease claims and nutrition support claims.

Nutrient-content claims describe the level of a nutrient in a food or dietary supplement. Disease claims show a link between a food or substance and a disease or health-related condition. FDA authorizes these claims based on a review of scientific evidence. A need exists in this industry to provide a cost efficient way to test nutritional supplements on a large sample of consumers.

### BRIEF SUMMARY OF THE INVENTION

In view of the foregoing, a method and system for testing nutritional supplements is provided. More specifically, this invention provides a method of confidentially providing laboratory results to a consumer of a fluid sample retrieval kit. This method involves obtaining at least one aliquot of fluid from the consumer of a fluid sample retrieval kit; selecting a personal identification number by the consumer; labeling the aliquot of fluid with a unique identification number; correlating the personal identification number and the unique identification number; transmitting the at least one aliquot of fluid to a physically remote laboratory for testing; testing the at least one aliquot of fluid for at least one clinical chemistry to obtain at least one clinical chemistry value; correlating the at least one clinical chemistry value with the unique identification number; and electronically providing the at least one clinical chemistry value to the consumer of the fluid sample retrieval kit, in response to receiving the personal identification number.

Additionally, this invention provides a method to compare clinical chemistry values from a plurality of consumers of a fluid sample retrieval kit. This method involves the steps of: (1) obtaining a plurality of clinical chemistry values from a plurality of consumers of said fluid sample retrieval kit to provide a nutritional supplement database; (2) scanning the nutritional supplement database for a designated nutritional supplement; and (3) providing a report on the plurality of clinical chemistry values for the designated nutritional supplement.

This invention provides a method to provide a plurality of databases. This method involves providing a fluid sample retrieval kit for obtaining at least one aliquot of fluid from a consumer, testing the at least one aliquot of fluid for at least one clinical chemistry to obtain at least one clinical chemistry value, obtaining a plurality of clinical chemistry values for more than one consumer to provide a confidential clinical chemistry result database, and transferring the data from the confidential clinical chemistry result database to a database for designated nutritional supplements. Additionally, this invention provides a method with the additional steps of correlating the at least the clinical chemistry value with a unique identification number, correlating a personal identification number with the unique identification number and providing access to the confidential clinical chemistry result data base by a consumer of the fluid sample retrieval system in response to a personal identification number.

This invention provides a method to determine the effect of a designated nutritional supplement on a subject. This method involves the steps of providing a plurality of fluid sample retrieval kits for obtaining at least an aliquot of fluid from a subject, testing the at least one aliquot of fluid for at least one clinical chemistry to obtain at least one clinical chemistry value, designating at least one nutritional supplement used by the subject, providing at least one personal health profile factor for the subject, correlating a plurality of clinical chemistry values from a plurality of subjects and correlating a plurality of clinical chemistry values with a designated nutritional supplement to determine the effect of a designated nutritional supplement on a subject.

This invention provides a method to compare clinical chemistry values from a plurality of consumers of a fluid sample retrieval kit for at least one designated nutritional supplement. This method involves the steps of providing a fluid sample retrieval kit for obtaining at least one aliquot of fluid from a consumer of a fluid sample retrieval kit, obtaining at least one aliquot of fluid from the consumer, designating at least one nutritional supplement taken by the consumer, obtaining a plurality of clinical chemistry values from more than one consumer of the fluid sample retrieval kit to provide a nutritional supplement database, scanning the database for a designated nutritional supplement and providing a report on the plurality of clinical chemistry values for the designated nutritional supplement.

This invention provides a fluid sample retrieval system. It involves the system components including a fluid sample retrieval kit containing at least one tube to receive an aliquot of bodily fluid, means to obtain an aliquot of bodily fluids, means to transmit the aliquot of bodily fluid to a physically remote testing laboratory, means to designate nutritional supplements consumed by the consumer, means to detect or determine at least one clinical chemistry value for the aliquot of bodily fluid by the distant laboratory, means to retrievably filing at least one of clinical chemistry values correlated with a personal identification number, means for consumer of fluid sample retrieval system to access at least one clinical chemistry value associated with the personal identification number, means to obtain personal health profile factors, means to sort at least one clinical chemistry value by the designated nutritional supplement and means to sort at least one clinical chemistry value by the personal health profile factors.

### BRIEF DESCRIPTION OF THE DRAWINGS

FIG. 1 is a perspective drawing of a sample retrieval kit.

FIG. 2 is a perspective view of a plastic container including tubes.

FIG. 3 is an embodiment of the order form.

FIG. 4 is a schematic diagram of fluid sample system.

FIG. 4A is a block diagram schematically illustrating one operating format of the testing system of the present invention, showing the processing function.

FIG. 4B is a block diagram schematically illustrating one operating format of the testing system of the present invention, showing the processing function.

FIG. 4C is a block diagram schematically illustrating one operating format of the testing system of the present invention, showing the processing function.

FIG. 5 is a block diagram showing statistical analysis method.

FIGS. 6A-6F are a series of block diagrams illustrating the statistical analysis associated with the clinical chemistry supplement analysis database.

FIG. 7 shows triglyceride single supplements.

FIG. 8 shows triglyceride two supplement combinations.

FIG. 9 shows triglyceride three supplement combinations.

FIG. 10 shows triglyceride four supplement combinations.

FIG. 11 shows triglyceride comparison of optimal combinations.

FIG. 12 shows LDL cholesterol single supplements.

FIG. 13 shows LDL cholesterol two supplement combinations.

FIG. 14 shows LDL cholesterol three supplement combinations.

FIG. 15 shows LDL cholesterol four supplement combinations.

FIG. 16 shows LDL cholesterol comparison of optimal combinations.

FIG. 17 shows glucose single supplements.

FIG. 18 shows glucose two supplement combinations.

FIG. 19 shows glucose three supplement combinations.

FIG. 20 shows glucose four supplement combinations

FIG. 21 shows glucose comparison of optimal combinations.

FIG. 22 shows a flow chart of clinical chemistry values report card.

FIG. 23 shows a sample graph of clinical chemistry values.

FIG. 24 shows a flow chart of supplement usefulness in clinical chemistry value analysis.

FIG. 25 shows a sample graph of clinical chemistry values.

### DETAILED DESCRIPTION OF THE PREFERRED EMBODIMENT

A fluid sample retrieval system is provided that allows a consumer to purchase a fluid sample retrieval kit and to have his or her fluid tested by a CLIA certified and state licensed laboratory for selected clinical chemistries. The clinical chemistry results are cross-referenced with designated nutritional supplements of which the consumer has indicated that he or she is taking on a continuous basis. The term “nutritional supplement” includes medical foods, such as infant formula like Lo-fenalac®, and dietary supplements such as products made of one or more of an essential nutrient, such as a vitamin, mineral, protein, herb botanical, plant-derived substances, amino acids, concentrates, metabolites or constituents or extracts of these substances. More specifically, nutritional supplements include, but are not limited to, the following products:—Classic, NOW, Ultrim, Innergize, Celebrate and Arthrotec (Reliv International, Inc., Chesterfield, Mo.); Majestic Earth Ultimate, Majestic Earth Colloidal Minerals, Majestic Earth Osteo-Cal, Majestic Earth Herbal Rainforest, Majestic Earth Tropical Plus, Majestic Earth Sport's Tech, Ultimate Resolution, Majestic Earth Oxybody and Osyaloe, ultimate Gluco-Gel, CM Plus, Ultimate EFA, Ultimate Nature's Whey, Ultimate Daily; Life Plus (American Longevity, Chula Vista, Calif.); Advance Pack with Colodyne, Alko-mar, Aminolyze, Berry'd Treasure, Calmag Plus, Candycal, Cardio-Chelax, Catagesic, Catimune, Catsclaw Forte Drops, Circulex, Clear Edge, Colloidal Silver, Colodyne, Combat, Co-Q-10 Plus, Biobasics, Diuplex Ecology Pak, EPA Plus, Essential Pak with Colodyne, Food for Thought (Life Plus, Batesville, Ark.).

A nutritional supplement data bank with unique identification numbers and no patient information other than the name of the nutritional supplements the subject is taking is provided. This data bank also contains the name of the manufacturer who manufactured those nutritional supplements. This data bank is used to determine the effectiveness of these nutritional supplements. In the case of some manufacturers there is the potential to document utilization of that company's product by hundreds of thousands of individuals. Assuming that company's product is effective, hundreds of thousands of sets of data documented by quarterly testing of these individuals will be invaluable in that company's efforts to satisfy the various governmental agencies as to the indication and effectiveness of that company's product.

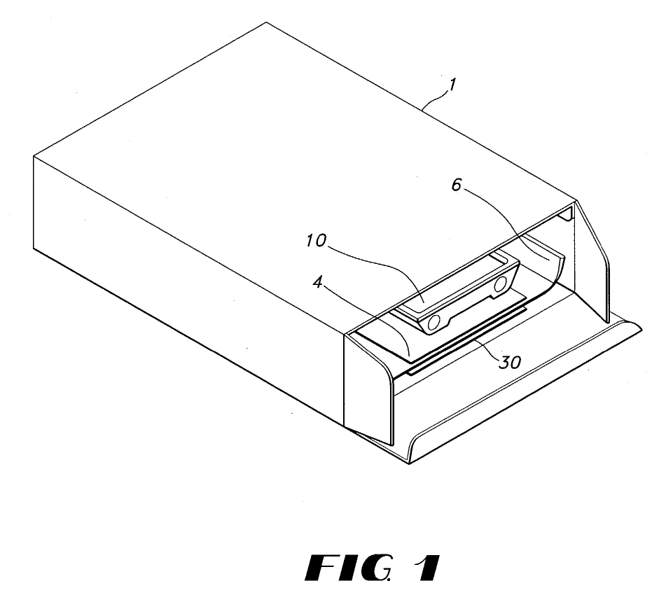

A fluid sample retrieval kit 1 is a container sized to accommodate at least one tube to receive an aliquot of bodily fluid from a subject. The embodiment of the fluid sample retrieval kit 1, as shown in FIG. 1, includes a container 10 containing at least one tube to receive an aliquot of bodily fluid, an order form 30, a booklet 4 explaining the clinical chemistries and procedures and a container 6 to transmit at least one tube 20 of bodily fluid to a physically remote testing laboratory.

The fluid sample retrieval kit 1 can be distributed to consumers in a retail environment or the fluid sample retrieval kit 1 can be distributed to physician offices, clinics, hospitals or institutions, such as, prisons or jails. The person who has an aliquot or fluid drawn, designates a nutritional supplement and optionally provides a personal health profile is known as a subject. If the subject directly purchases the fluid sample retrieval kit 1 then the subject is a consumer.

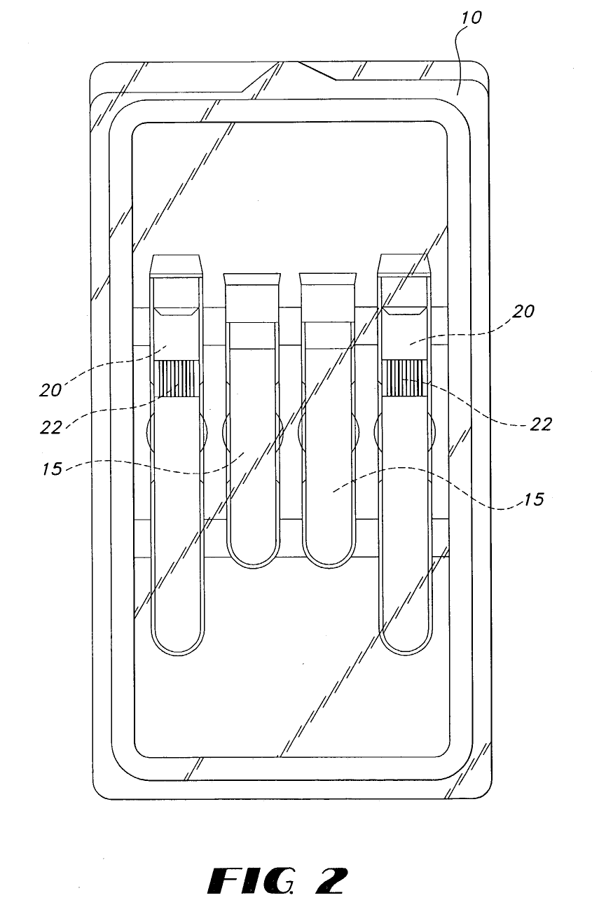

Now referring to FIGS. 1 and 2, a consumer purchases a fluid sample retrieval kit 1. The fluid sample retrieval kit 1 can be purchased from a retail store, over the Internet, or by placing an order via the telephone. A fluid sample retrieval kit 1 in its most basic embodiment includes a container 10. The container 10 is sized to include at least one serum transport tube 20. Additionally, the container 10 can be sized to include at least one serum transport tube 20 and in the preferred embodiment, the container 10 is a plastic box sized to accommodate two transport tubes 20 and two serum separation tubes 15. The serum separation tube is sized to receive between about 7 to 8.5 ml of blood drawn from a consumer. This amount is referred to as an “aliquot” of fluid. If the specimen is blood, the blood is obtained from the consumer via conventional techniques is by a nurse or other trained healthcare professional at a clinic or hospital. The consumer must go to a facility to have the blood drawn and provide the blood drawn facility with the fluid sample retrieval kit 1. The serum is separated from the blood by conventional techniques in one of the serum separation tubes 15. Then, about 6 ml of serum is added to at least one transport tube 20. The transport tube 20 is sized to receive an aliquot of fluid. If the specimen is urine, about 6 ml of urine is added to the transport tube 20. The transport tube 20 includes a bar code reference number on the cap (not shown) or on the tube itself 22. The fluid sample retrieval kit 1 can also contain an order form 30. The fluid sample retrieval kit 1 can also contain a means to mail the transport tube 20 and a completed order form 30 to a central processing facility. This means can include a pouch or envelope 6. The fluid sample retrieval system kit 1 can also contain a booklet 4 that includes information on test selection, laboratory services available and a permission to test. The clinical chemistries that can be conducted on at least on aliquot of fluid include all standard clinical chemistries. More specifically, the clinical chemistry can include for example albumin, alkaline phospatase, bilirubin, blood urea nitrogen, calcium, chloride, cholesterol, creatinine, gamma-glutamyl transaminase, globulin, glucose, HDL cholesterol, lactic dehydrogenase, LDL cholesterol, phosphorous, potassium, sodium, serum glutamic pryurate transaminase, serum glatmic pyruvate transaminase, thyroid panel, triglyceride, HIV, hepatitis and uric acid.

In the preferred embodiment, a fluid sample retrieval kit 1 includes a container 10 containing at least one fluid transport tube 20, order form 30 and a container 6 means to transmit at least one fluid transport tube 20 of bodily fluid to a physically remote laboratory 25, if the fluid sample retrieval kit 1 is not distributed directly to a consumer. If the fluid sample retrieval kit 1 is directly purchased by a consumer, the fluid sample retrieval kit 1 includes at least one serum separation tube 15, at least one fluid transport tube 20, container 6 meant to transmit at least one fluid transport tube 20 to a physically remote testing laboratory 25, a booklet 4 and order form 30.

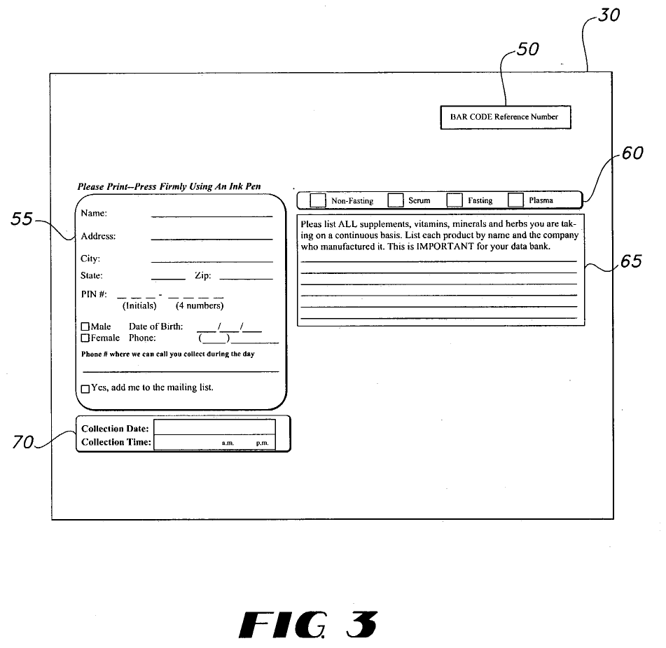

Now referring to FIG. 3, an example of an order form 30 is shown. The order form 30 includes box 50 for a bar code reference number. The bar code reference number included on order form 30 is correlated with a bar code reference number 22 on the transport tubes 20. The bar code reference number 22 is a unique identification number that identifies the fluid sample and the clinical chemistry tests conducted on the fluid sample. The consumer in box 55 can include information such as name, address, city, state, personal identification number (PIN), gender, date of birth, and phone number. The PIN number is correlated with the bar code reference number 22. In box 60, the consumer indicates information on the fluid sample. In box 65 the consumer provides information on designated nutritional supplements, vitamins, minerals and herbs taken on a continuous basis. The products are listed by name and company of manufacturer in box 65. The central processing facility will send a questionnaire to a consumer if box 65 includes any nutritional supplements. If the consumer marks box 65 of order form 30, then a correspondence is generated from the central processing facility with the consumer regarding nutritional supplementation. This correspondence with the consumer can include information on lifestyle, dietary intake, social habits, testing frequency, family history, social history (e.g. alcohol, tobacco or drug use). The questionnaire (personal health profile) is sent to the central processing facility with the second specimen. In box 70 the date and time of the collection of the aliquot of fluid is recorded.

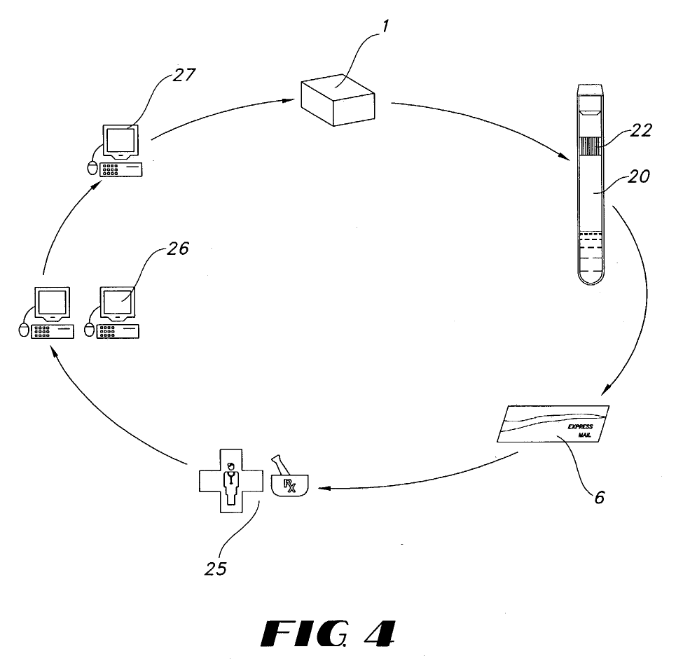

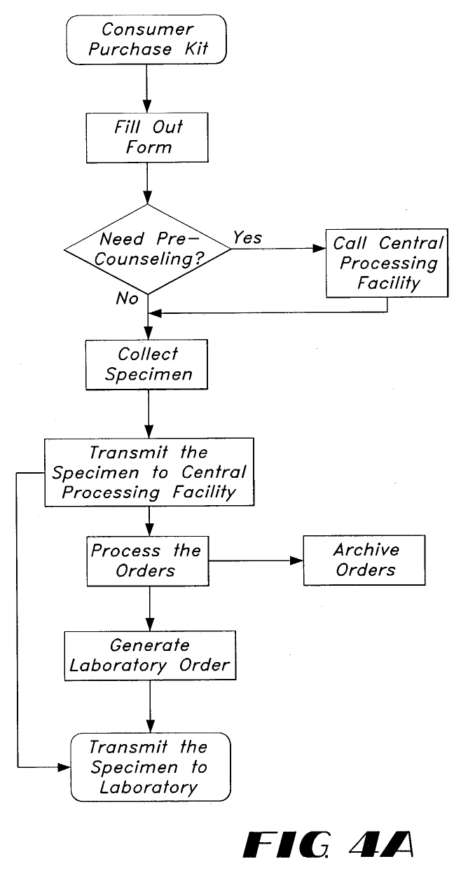

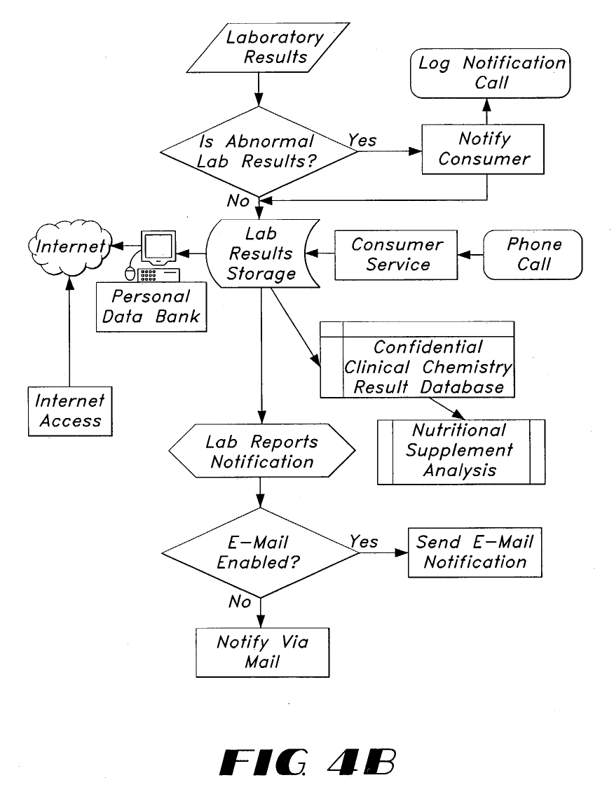

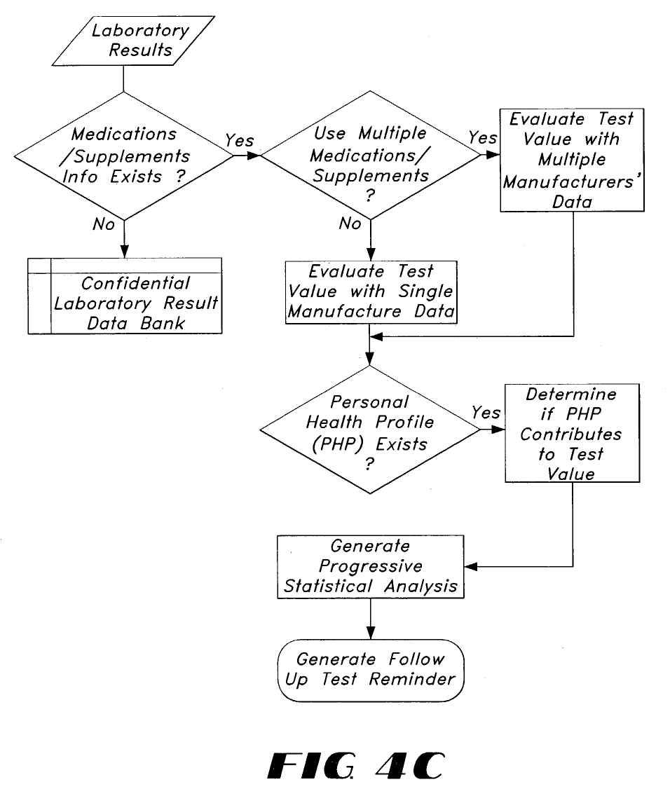

Now referring to FIG. 4, an overview of the fluid sample retrieval system is shown. More specifically, a fluid sample retrieval kit 1 containing a transport tube 20 to receive at least one aliquot of bodily fluid is purchased by a consumer. A means to obtain an aliquot of bodily fluid is provided. For example, the consumer takes the blood sample retrieval kit 1 to a clinic or laboratory to have an aliquot of bodily fluids withdrawn and deposited within the transport tube 20. A means to transmit the aliquot of bodily fluid to a physically remote laboratory 25 is provided. This means may include a container 6, pouch, envelope or box sized to accommodate a fluid transport tube 20 and be suitable to be transmitted via U.S. mail or by a private carrier, such as Federal Express® (Memphis, Tenn.). Additionally, this system includes a means to designate nutritional supplements consumer by the consumer. This can include an order form 30 with box 65 for information on designated nutritional supplements, vitamins, minerals and herbs taken on a continuous basis. Additionally, this system includes a means to detect or determine at least one clinical chemistry value for the aliquot of bodily fluid sent to the physically remote laboratory 25. The aliquot of blood is tested by a laboratory at least one clinical chemistry value. A plurality of clinical chemistry values are collected for a plurality of samples received by the laboratory and each sample is correlated with the bar code reference number. Additionally, this system provides a means to retrievable file at least one clinical chemistry value correlated with a personal identification number. This data can be retrievably filed in the central computers 26 of the central processing facility. The central processing facility is a computer including computer software to file and sort this data. The clinical chemistry values associated with a bar code reference number and the personal identification number are stored in computer database of central computers 26 of the central processing facility. The clinical chemistry values associated with a personal identification number are accessible by the consumer of the fluid sample retrieval system. More specifically, this system provides a means for the consumer of the fluid sample retrieval system to access at least one clinical chemistry value associated with the personal identification number. This can be accomplished by accessing the central computers 26 via the internet using the consumer computer 27, via the telephone, via U.S. mail, or private carrier. The process is repeated by the consumer purchasing a second fluid sample retrieval kit 1. Upon receiving the second aliquot of bodily fluids, a personal health profile is sent to the consumer to obtain personal health profile factors. The system further provides a means to sort at least one clinical chemistry value by the designated nutritional supplement and means to sort at least one clinical chemistry value by the personal health profiles. The system further provides a means to chart at least one clinical chemistry value by the designated nutritional supplement and means to chart at least one clinical chemistry value by the personal health profiles. This chart is used to reflect the progression of the changes in the clinical chemistry values in relation with the use of the various nutritional supplements and individual personal health profile.

Now referring to FIG. 4A, the consumer purchases a fluid sample retrieval system kit and fills out the order form 30. If the consumer needs pre-counseling, the consumer can call the central processing facility. If pre-counseling is not needed, the specimen (fluid and/or urine) is collected and added to the transport tube 20. The transport tube 20 is transmitted to the central processing facility to process the order. The central processing facility generates an order for testing by the Laboratory and transmits at least one aliquot of fluid to the laboratory for testing. The transport tube 20 includes a unique identification number that is, or correlated with, a barcode reference number on the order form. In an alternative embodiment, the specimen and order are sent directly to the laboratory.

Now referring to FIG. 4A, the laboratory tests at least one aliquot of fluid for the requested clinical chemistry tests and the clinical chemistry values are correlated with the unique identification number to provide laboratory results. If the clinical chemistry results are abnormal, i.e. beyond the recognized parameters, then the consumer is notified via electronic or regular mail. If the laboratory results are normal, then the lab results are sent storage. From storage, the laboratory results can be processed in a variety of ways. First, the laboratory results can be confidentially provided to a consumer via the Internet. For example, a consumer can access the central provider's website and click on a link to view a copy of the laboratory order or laboratory results in a confidential clinical chemistry result database. The PIN grants access to the consumer's personal data bank which only contains three sets of data. The order number is the bar code reference number. In another embodiment, the consumer can call a designated phone number to reach the central consumer services to be read the lab report upon providing the personal processing facilities identification number. In another alternative embodiment, the lab reports are mailed to the consumer.

The laboratory results are sent to a confidential laboratory result data bank and nutritional supplement analysis is conducted. Referring to FIG. 4B, a block diagram of the nutritional supplement analysis is shown. A plurality of consumer fluid samples are analyzed for selected clinical chemistries. The results of this analysis are included in a confidential clinical chemistry result database. The data in this data bank is accessible by the consumer via the Internet with a personal identification number. The data in the confidential clinical chemistry result database is transferred to a second database, the nutritional supplement analysis database for nutritional supplement analysis. The data in the nutritional supplement analysis data base is identified by a code and may be categorized by manufacturer supplement provided by a manufacturer, and categorized by combination of usage of each supplement produced by that manufacturer. A code will be established to maintain the individuals' privacy in the nutritional supplement data bank. This data is used to provide a base line measurement for each clinical chemistry. A report on designated clinical chemistry values for a plurality of clinical chemistry values is provided.

Now referring to FIG. 4C, certain laboratory results are subjected to nutritional supplement analysis. In particular, it is determined whether medication or supplement information exists. If no medication or supplement information is documented on the order form 30, the clinical chemistry values are restricted to the confidential laboratory result databank, which is accessible by that consumer's PIN. If medication or supplement information exists, then the test data is evaluated for single or multiple manufacturing data. This database includes data grouped according to manufacture of nutritional supplements. This level of entry is to establish a base line of the medical laboratory testing results for a particular consumer who has indicated he or she is indeed taking a nutritional supplement, vitamin or herb manufactured by a particular company. No statistical analysis will be performed on the consumer's first series of metabolic and nutritional medical laboratory test results. The return of the requisition form indicating the use of nutritional supplements, vitamins, herbs and a manufacturer, activates the return of the consumer's medical laboratory results, along with a questionnaire, which upon return, is that consumer's personal health profile (PHP).

Once the evaluation is complete, it is determined whether a PHP exists. A PHP questionnaire is sent to the consumer after the first specimen is received. The PHP is the history of that individual. Personal health profile factors include a social history, such as use of drugs, i.e. tobacco, alcohol, or illicit drugs, medical history including surgical history, sex, weight, marital status, prescription medications, and family history, including medical history of relatives. This PHP factors will allow an expansion of the statistical analysis should a particular manufacturer request an analysis of their distributor families' medical laboratory testing, i.e. testing for correlation with use of tobacco, etc. The databank for nutritional supplement analysis will be activated by receipt of the second specimen, along with the PHP questions.

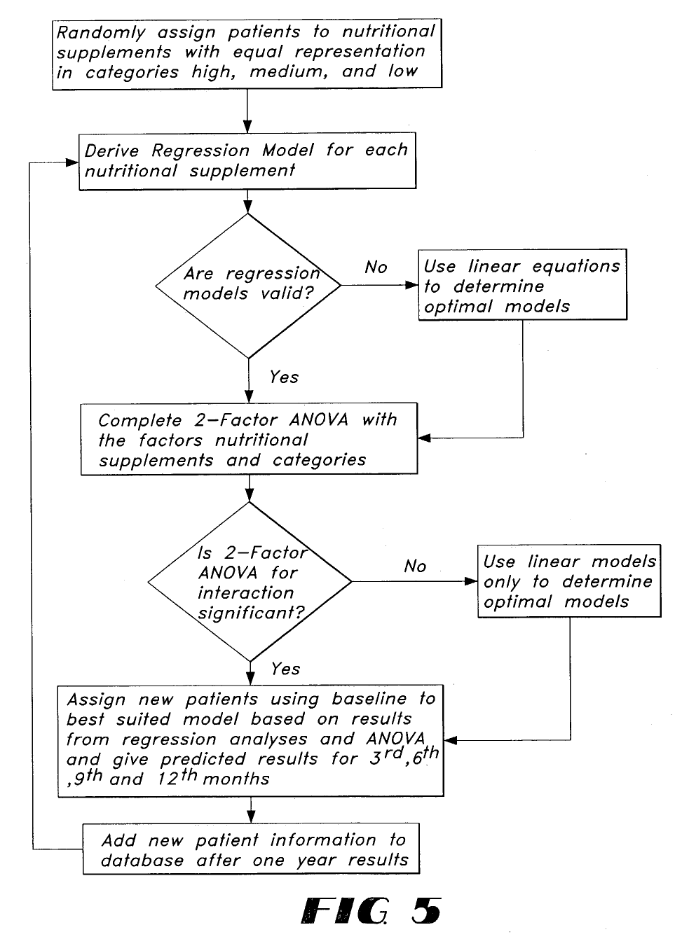

If a PHP exists, a progressive statistical analysis is generated (FIG. 5). The progressive statistical analysis is a continuous comparison of the clinical chemistry values as related to the base line clinical chemistry values for that consumer. In addition, the progressive statistical analysis will continue to compare the clinical chemistry values with the most recent clinical chemistry values, as well as the previous month or quarterly testing. This statistical analysis is contingent upon strict compliance by the individual consumer following the testing protocol. Reminder letters are sent to the consumer to encourage compliance with the testing protocol. The next step involves sending out a follow-up test reminder.

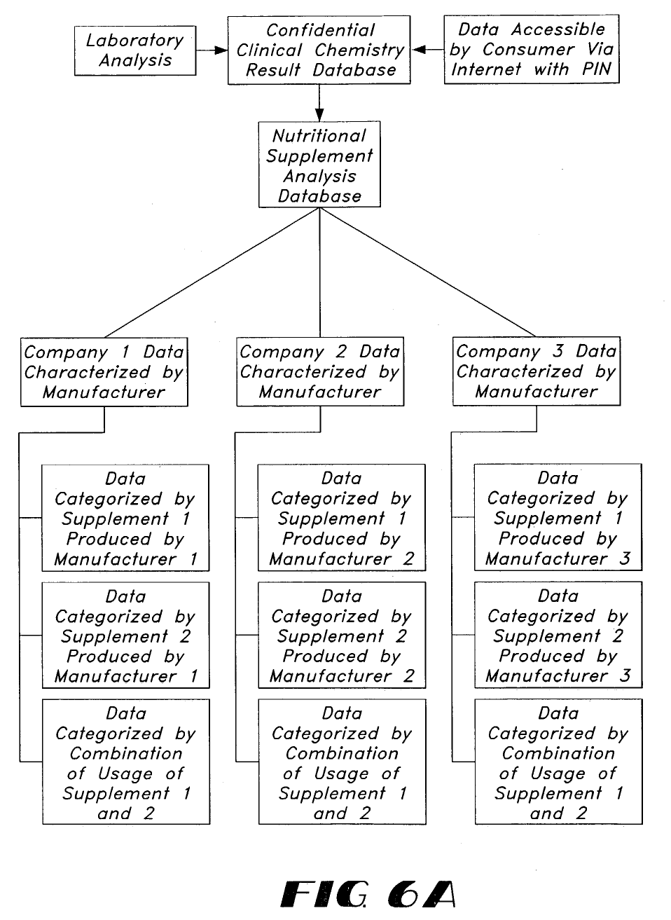

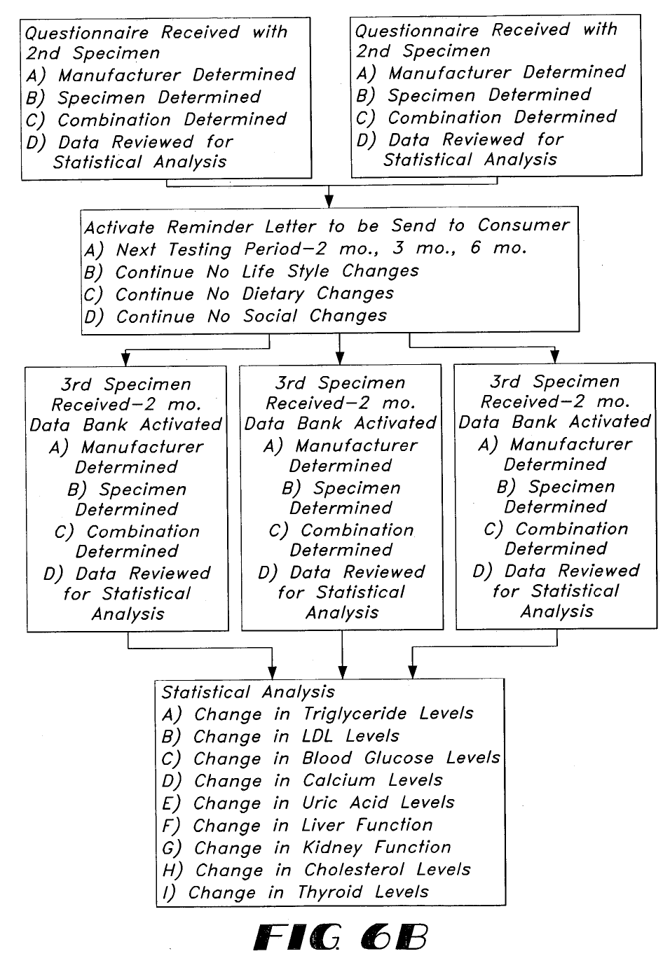

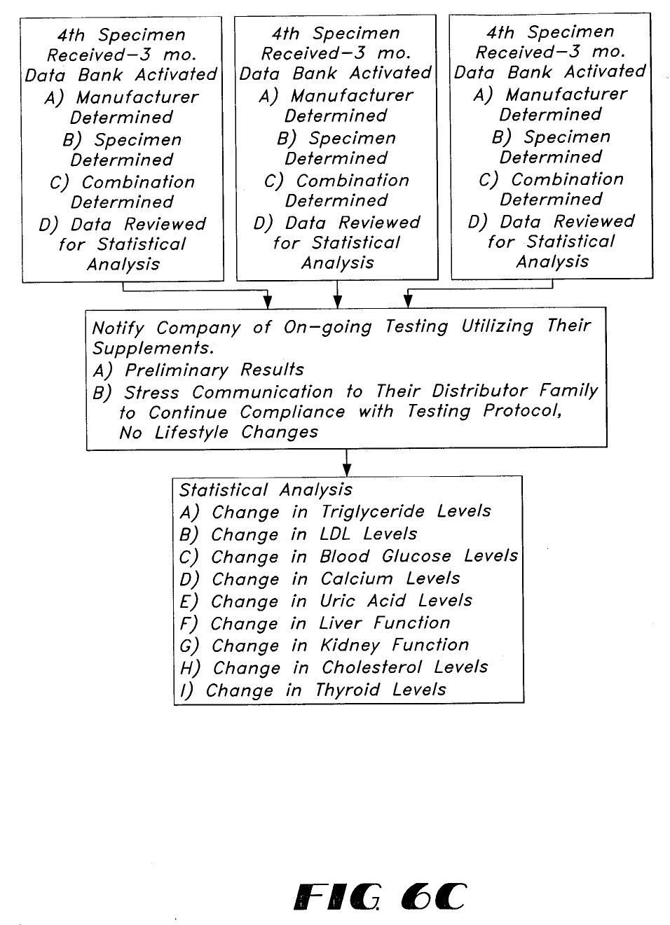

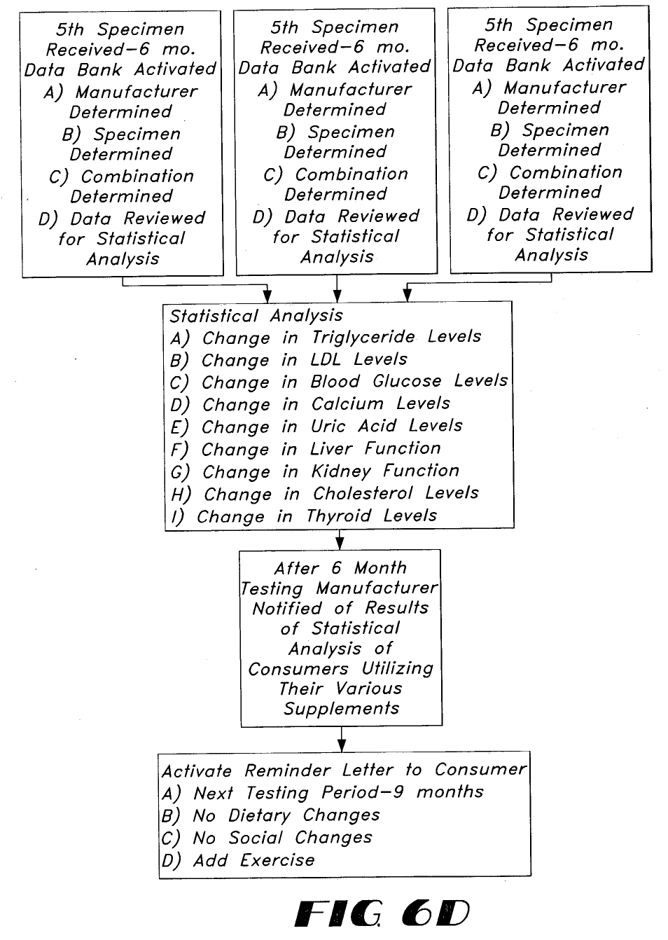

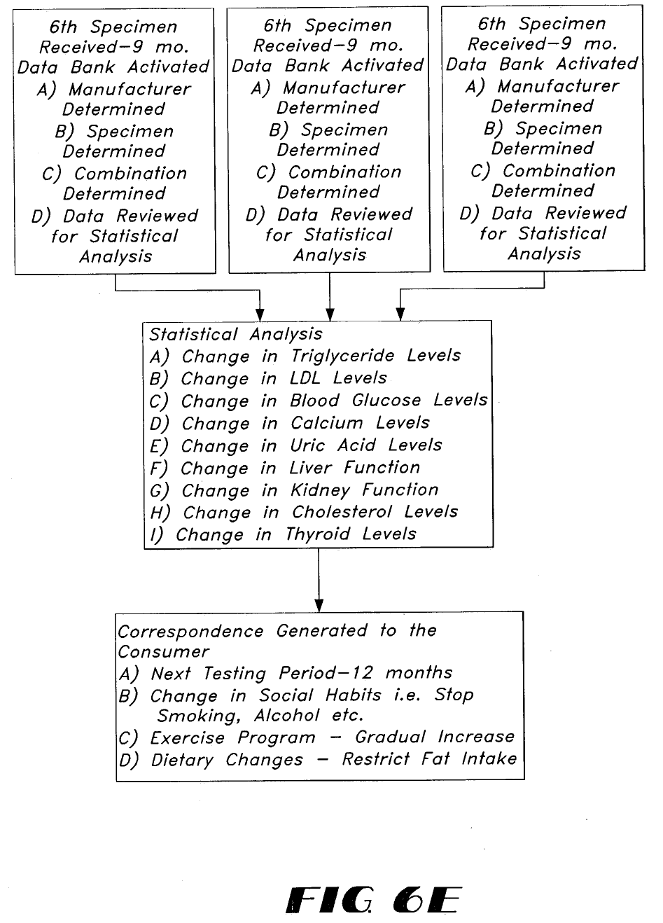

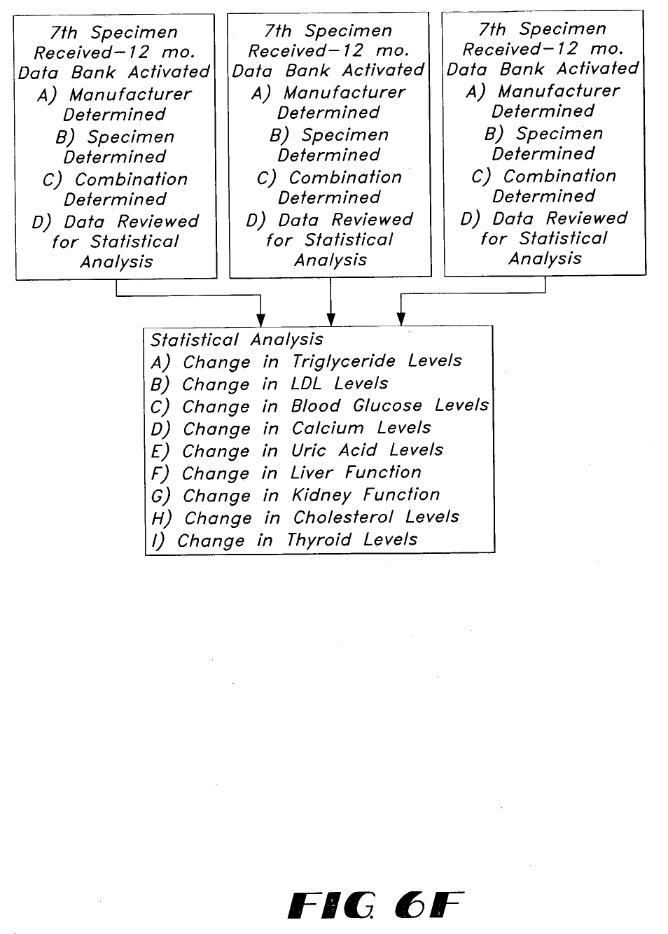

Now referring to FIGS. 6A-6E, in response to receiving the second specimen, the manufacturers, the supplement and combination of usages of those supplements are determined and the data is subjected to statistical analysis. The statistical analysis includes changes in the clinical chemistries such as:

A) Change in triglyceride levels

B) Change in LDL levels

C) Change in fluid glucose levels

D) Change in calcium levels

E) Change in uric acid levels

F) Change in liver function

G) Change in kidney function

H) Change in cholesterol levels

I) Change in thyroid levels

A reminder letter is sent to the consumer to notify of the next testing periods (i.e. 2 months, 3 months, and 4 months). The consumer is advised to continue no lifestyle changes, dietary of social changes. As each specimen is received, the manufacturers, the nutritional supplement or combination of nutritional supplements is determined and the data is subjected to statistical analysis.

When the third specimen is received, the database is activated: the manufacturer determined, supplement and the combination of supplements are determined and the data reviewed for statistical analysis as previously described.

When the fourth specimen is received, the database is activated: the manufacturer determined, the nutritional supplement or combination of nutritional supplements is determined and the data reviewed for statistical analysis as previously described.

A manufacturer is notified concerning ongoing testing utilizing their supplement.

When the fifth specimen is received, the database is activated: the manufacturer determined, the nutritional supplement or combination of nutritional supplements is determined and the data reviewed for statistical analysis as previously described.

After six months of testing, the manufacturer is notified of statistical analysis of consumers using their various supplements. A reminder letter is sent to consumers that the next testing period is nine months, that there should be no dietary changes or social changes, and to add exercise.

When the sixth specimen is received, the database is activated: the manufacturer determined, the nutritional supplement or combination of nutritional supplements is determined and the data reviewed for statistical analysis as previously described.

A correspondence is generated to the consumer that the next testing period is 12 months, to change social habits (stop smoking, etc.), add an exercise program, and to make dietary changes such as restrict fat intake.

After the specimen is received, the database is activated: the manufacturer determined, the nutritional supplement or combination of nutritional supplements is determined and the data reviewed for statistical analysis as previously described.

### EXAMPLE 1

The population of individuals utilized for this statistical analysis represents the distributor family for a large, international nutritional supplement company. The percentages derived are based on actual studies and percentages detailed in those studies to include: the NHANES III study, which is the Third National Health and Nutritional Examination Study, the DECODE study or Diabetic Epidemiology And Collaborative Analysis Criteria In Europe as well as the MRFIT or Multiple Risk Factor Intervention Trial. These various studies were performed to indicate the need for better control of the fasting and post prandial blood glucose levels in individuals with Diabetes Mellitus as well as elevated cholesterol, triglyceride and LDL (bad) cholesterol. It is well known there are ten million Americans who have Diabetes Mellitus and at least another five million Americans who have Diabetes Mellitus but are not yet diagnosed with this disease. Over half of the population of the United States is overweight. Statistics have shown that of the diabetic individuals who have died, sixty five percent died due to cardiovascular complications.

The DECODE study (Cardiology, February 2001, Vol. 18, No. 2, pp. 28-31) included 27,206 individuals, of which 1,288 had a previous diagnosis of Diabetes Mellitus. The MRFIT study (Cardiology, April 2000, Vol. 17, No. 4, pp. 13-19) included 5,000 individuals with Diabetes Mellitus and 350,000 who did not have Diabetes Mellitus. This study indicated the risk of cardiovascular disease was three times higher in the diabetic individuals regardless of other factors. The NHANES III study (Jama, Jan. 16, 2002, Vol. 287, No. 3, pp. 356-359) included 8,814 individuals, which was felt to be a true cross section of the population of the noninstitutionalized population in the United States. The results of this study indicated an average increase in triglycerides, LDL (low density lipoproteins-bad) cholesterol and fluid sugar in men of 35.1%, 35.2% and 15.8% respectively. In women, these percentages were 24.7%, 39.3% and 10% respectively. Utilizing these studies, the assumption has been made that in the population of the distributor family of the major nutritional supplement company represented in this statistical analysis, there would be similar elevations of triglycerides, LDL cholesterol and fluid glucose levels. Further assumptions made in the statistical analysis are based on twenty seven years of medical practice experience. Those assumptions are the average level of elevated triglyceride level is 350 mg/dl, with the upper limit of normal being 160 mg/d. The average level of LDL (low density lipoprotein level) is 200 mg/dl, with the upper limits of normal being 130 mg/dl. The average elevated level of fluid glucose is 280 mg/dl with the upper limit of normal being 110 mg/dl.

At the onset of the hypothetical study (date of the initial purchase of the fluid sample retrieval system), each individual would (as previously detailed) have a triglyceride level of 350 mg/dl, a LDL cholesterol of 200 mg/dl and a fluid glucose level of 280 mg/dl. At the time of the first period (1 month), the decrease in each of these levels will be determined by the combination of supplements utilized in that testing period. The following is a list of normally observed through application triglyceride levels for the individuals utilizing each of the six supplements during the first testing period (1 month).

A) 332 mg/dl

B) 339 mg/dl

C) 343 mg/dl

D) 339 mg/dl

E) 339 mg/dl

F) 339 mg/dl

There is an anticipated synergistic effect when the various supplements are utilized concurrently; therefore, the anticipated triglyceride levels will change as indicated below for the first testing period (1 month).

Triglyceride Testing - Month 1

| | | | | |
|---|---|---|---|---|
| A + C | A + E | C + E | C + D + E | D + E + F |
| 325 mg/dl | 325 mg/dl | 339 mg/dl | 325 mg/dl | 329 mg/dl |
| B C | A + F | D + F | A + E + F | A + C + E + F |
| 332 mg/dl | 329 mg/dl | 329 mg/dl | 325 mg/dl | 325 mg/dl |
| C + D | B + E | A + C + E | B + E + F | B + C + E + F |
| 332 mg/dl | 329 mg/dl | 322 mg/dl | 329 mg/dl | 325 mg/dl |
| D + E | B + F | B + C + E | C + E + F | C + D + E + F |
| 329 mg/dl | 329 mg/dl | 325 mg/dl | 334 mg/dl | 325 mg/dl |

The second testing period (second month) reflects the physiological changes in the human body as it adjusts to adequate and appropriate nutritional supplement utilization. As previously noted, the addition of the various nutritional supplements has a synergistic effect on the human body. The following is a list of normally observed through application triglyceride level for those individuals utilizing the various combinations of the six supplements during the second testing period (second month).

Triglyceride Testing - Month 2

| | | | | | |
|---|---|---|---|---|---|
| A | B | C | D | E | F |
| 308 mg/dl | 315/mg/dl | 343 mg/dl | 315 mg/dl | 341 mg/dl | 341 mg/dl |
| A + C | B + C | C + D | D + E | A + E | C + F |
| 297 mg/dl | 308 mg/dl | 308 mg/dl | 315 mg/dl | 308 mg/dl | NA |
| A + C + E | B + C + E | C + D + E | D + F | B + E | B + F |
| 301 mg/dl | 308 mg/dl | 308/mg/dl | 308 mg/dl | 308 mg/dl | 308 mg/dl |
| A + C + | B + C + | C + D + | D + E + F | E + C | A + F |
| E + F | E + F | E + F | 308 mg/dl | 341 mg/dl | 308 mg/dl |
| 297 mg/dl | 301/mg/dl | 301 mg/dl | | | |
| A + E + F | B + E + F | C + E + F | | | |
| 308 mg/dl | 308 mg/dl | 341 mg/dl | | | |

The third testing period (third month) represents the degree of compliance of the individual's utilization of the various supplements as well as the human body's continued adjustment to the appropriate nutritional supplement. As previously noted, the addition of the various nutritional supplements has a synergistic effect on the human body. The following is a list of normally observed through application triglyceride level for those individuals utilizing the various combinations of the six supplements during the third testing period (third month).

Triglyceride Testing - Month 3

| | | | | | |
|---|---|---|---|---|---|
| A | B | C | D | E | F |
| 297 mg/dl | 297 mg/dl | 343 mg/dl | 297 mg/dl | 341 mg/dl | 341 mg/dl |
| A + C | B + C | C + D | D + E | A + E | C + F |
| 280 mg/dl | 280 mg/dl | 280 mg/dl | 280 mg/dl | 287 mg/dl | NA |
| A + C + E | B + C + E | C + D + E | D + F | B + E | B + F |
| 280 mg/dl | 280 mg/dl | 280 mg/dl | 280 mg/dl | 280 mg/dl | 280 mg/dl |
| A + C + | B + C + | C + D + | D + E + F | E + C | A + F |
| E + F | E + F | E + F | 297 mg/dl | 332 mg/dl | 297 mg/dl |
| 273 mg/dl | 280 mg/dl | 280 mg/dl | | | |
| A + E + F | B + E + F | C + E + F | | | |
| 287 mg/dl | 280 mg/dl | 329 mg/dl | | | |

The fourth testing period (sixth month) represents the degree of compliance of the individual's utilization of the various supplements as well as the human body's continued adjustment to the appropriate nutritional supplement. As previously noted, the addition of the various nutritional supplements has a synergistic effect on the human body. The following is a list of normally observed through application triglyceride level for those individuals utilizing the various combinations of the six supplements during the fourth testing period (sixth month).

Triglyceride Testing - Month 6

| | | | | | |
|---|---|---|---|---|---|
| A | B | C | D | E | F |
| 280 mg/dl | 287 mg/dl | 343 mg/dl | 287 mg/dl | 341 mg/dl | 341 mg/dl |
| A + C | B + C | C + D | D + E | A + E | C + F |
| 280 mg/dl | 280 mg/dl | 280 mg/dl | 287 mg/dl | 280 mg/dl | NA |
| A + C + E | B + C + E | C + D + E | D + F | B + E | B + F |
| 280 mg/dl | 280 mg/dl | 280 mg/dl | 280 mg/dl | 273 mg/dl | 280 mg/dl |
| A + C + | B + C + | C + D + | D + E + F | E + C | A + F |
| E + F | E + F | E + F | 287 mg/dl | 332 mg/dl | 273 mg/dl |
| 273 mg/dl | 280 mg/dl | 280 mg/dl | | | |
| A + E + F | B + E + F | C + E + F | | | |
| 287 mg/dl | 280 mg/dl | 315 mg/dl | | | |

The fifth testing period (ninth month) represents the continued degree of compliance of the individual's utilization of the various supplements. This period of testing also reflects the additional effects of weight loss in certain individuals utilizing the supplements for weight loss and the effects of exercise on the human body. As previously noted, the addition of the various nutritional supplements has a synergistic effect on the human body. The following is a list of normally observed through application triglyceride level for those individuals utilizing the various combinations of the six supplements during the fifth testing period (ninth month).

Triglyceride Testing - Month 9

| | | | | | |
|---|---|---|---|---|---|
| A | B | C | D | E | F |
| 273 mg/dl | 280 mg/dl | 343 mg/dl | 280 mg/dl | 341 mg/dl | 341 mg/dl |
| A + C | B + C | C + D | D + E | A + E | C + F |
| 273 mg/dl | 280 mg/dl | 273 mg/dl | 273 mg/dl | 273 mg/dl | NA |
| A + C + E | B + C + E | C + D + E | D + F | B + E | B + F |
| 273 mg/dl | 273 mg/dl | 273 mg/dl | 273 mg/dl | 273 mg/dl | 280 mg/dl |
| A + C + | B + C + | C + D + | D + E + F | E + C | A + F |
| E + F | E + F | E + F | 280 mg/dl | 315 mg/dl | 273 mg/dl |
| 273 mg/dl | 273 mg/dl | 273 mg/dl | | | |
| A + E + F | B + E + F | C + E + F | | | |
| 273 mg/dl | 273 mg/dl | 315 mg/dl | | | |

The sixth testing period (twelfth month) represents the faithful, continuous use of the various nutritional supplements over an extended period of twelve months. This testing period allows comparison to baseline studies as well as each quarterly testing period. It also allows for life style changes as well as diet, weight loss and exercise programs. As previously noted, the addition of the various nutritional supplements has a synergistic effect on the human body. The following is a list of normally observed through application triglyceride level for those individuals utilizing the various combinations of the six supplements during the sixth testing period (twelfth month).

Triglyceride Testing - Month 12

| | | | | | |
|---|---|---|---|---|---|
| A | B | C | D | E | F |
| 273 mg/dl | 280 mg/dl | 343 mg/dl | 280 mg/dl | 341 mg/dl | 341 mg/dl |
| A + C | B + C | C + D | D + E | A + E | C + F |
| 262 mg/dl | 280 mg/dl | 273 mg/dl | 273 mg/dl | 262 mg/dl | NA |
| A + C + E | B + C + E | C + D + E | D + F | B + E | B + F |
| 262 mg/dl | 262 mg/dl | 262 mg/dl | 273 mg/dl | 273 mg/dl | 280 mg/dl |
| A + C + | B + C + | C + D + | D + E + F | E + C | A + F |
| E + F | E + F | E + F | 262 mg/dl | 308 mg/dl | 273 mg/dl |
| 262 mg/dl | 262 mg/dl | 262 mg/dl | | | |
| A + E + F | B + E + F | C + E + F | | | |
| 262 mg/dl | 262 mg/dl | 315 mg/dl | | | |

The following is a list of normally observed through application LDL (low density lipoprotein-bad) cholesterol levels for the individuals utilizing each of the six nutritional supplements during the first testing period (1 month):

A) 190 mg/dl

B) 194 mg/dl

C) 196 mg/dl

D) 194 mg/dl

E) 194 mg/dl

F) 194 mg/dl

There is an anticipated synergistic effect when the various supplements are utilized concurrently; therefore, the anticipated hypothetical LDL (low density lipoprotein-bad) cholesterol levels will change as indicated below for the first testing period (1 month).

The second testing period (second month) reflects the physiological changes in the human body as it adjusts to adequate and appropriate nutritional supplement utilization. As previously noted, the addition of the various nutritional supplements has a synergistic effect on the human body. The following is a list of normally observed through application LDL (Low Density Lipoprotein-bad) Cholesterol level for those individuals utilizing the various combinations of the six supplements during the second testing period (second month).

LDL (Low Density Lipprotein - bad) Cholesterol Testing - Month 2

| | | | | | |
|---|---|---|---|---|---|
| A | B | C | D | E | F |
| 176 mg/dl | 180 mg/dl | 196 mg/dl | 180 mg/dl | 194 mg/dl | 194 mg/dl |
| A + C | B + C | C + D | D + E | A + E | C + F |
| 170 mg/dl | 176 mg/dl | 176 mg/dl | 176 mg/dl | 176 mg/dl | NA |
| A + C + E | B + C + E | C + D + E | D + F | B + E | B + F |
| 172 mg/dl | 176 mg/dl | 176 mg/dl | 176 mg/dl | 180 mg/dl | 176 mg/dl |
| A + C + | B + C + | C + D + | D + E + F | E + C | A + F |
| E + F | E + F | E + F | 180 mg/dl | 194 mg/dl | 176 mg/dl |
| 170 mg/dl | 172 mg/dl | 172 mg/dl | | | |
| A + E + F | B + E + F | C + E + F | | | |
| 180 mg/dl | 176 mg/dl | 194 mg/dl | | | |

The third testing period (third month) represents the degree of compliance of the individual's utilization of the various supplements as well as the human body's continued adjustment to the appropriate nutritional supplement. As previously noted, the addition of the various nutritional supplements has a synergistic effect on the human body. The following is a list of normally observed through application LDL (Low Density Lipoprotein-bad) Cholesterol level for those individuals utilizing the various combinations of the six supplements during the third testing period (third month).

LDL (Low Density Lipoprotein - bad) Cholesterol Testing - Month 3

| | | | | | |
|---|---|---|---|---|---|
| A | B | C | D | E | F |
| 170 mg/dl | 170 mg/dl | 196 mg/dl | 170 mg/dl | 194 mg/dl | 194 mg/dl |
| A + C | B + C | C + D | D + E | A + E | C + F |
| 160 mg/dl | 160 mg/dl | 160 mg/dl | 160 mg/dl | 164 mg/dl | NA |
| A + C + E | B + C + E | C + D + E | D + F | B + E | B + F |
| 160 mg/dl | 160 mg/dl | 160 mg/dl | 160 mg/dl | 160 mg/dl | 160 mg/dl |
| A + C + | B + C + | C + D + | D + E + F | E + C | A + F |
| E + F | E + F | E + F | 170 mg/dl | 190 mg/dl | 170 mg/dl |
| 160 mg/dl | 160 mg/dl | 160 mg/dl | | | |
| A + E + F | B + E + F | C + E + F | | | |
| 164 mg/dl | 160 mg/dl | 188 mg/dl | | | |

The fourth testing period (sixth month) represents the degree of compliance of the individual's utilization of the various supplements as well as the human body's continued adjustment to the appropriate nutritional supplement. As previously noted, the addition of the various nutritional supplements has a synergistic effect on the human body. The following is a list of normally observed through application LDL (Low Density Lipoprotein-bad) Cholesterol level for those individuals utilizing the various combinations of the six supplements during the fourth testing period (sixth month).

LDL (Low Density Lipoprotein - bad) Cholesterol Testing - Month 6

| | | | | | |
|---|---|---|---|---|---|
| A | B | C | D | E | F |
| 160 mg/dl | 164 mg/dl | 196 mg/dl | 160 mg/dl | 194 mg/dl | 194 mg/dl |
| A + C | B + C | C + D | D + E | A + E | C + F |
| 150 mg/dl | 160 mg/dl | 156 mg/dl | 156 mg/dl | 160 mg/dl | NA |
| A + C + E | B + C + E | C + D + E | D + F | B + E | B + F |
| 150 mg/dl | 150 mg/dl | 150 mg/dl | 156 mg/dl | 156 mg/dl | 160 mg/dl |
| A + C + | B + C + | C + D + | D + E + F | E + C | A + F |
| E + F | E + F | E + F | 150 mg/dl | 176 mg/dl | 156 mg/dl |
| 150 mg/dl | 150 mg/dl | 150 mg/dl | | | |
| A + E + F | B + E + F | C + E + F | | | |
| 156 mg/dl | 156 mg/dl | 180 mg/dl | | | |

The fifth testing period (ninth month) represents the continued degree of compliance of the individual's utilization of the various supplements. This period of testing also reflects the additional effects of weight loss in certain individuals utilizing the supplements for weight loss and the effects of exercise on the human body. As previously noted, the addition of the various nutritional supplements has a synergistic effect on the human body. The following is a list of normally observed through application LDL (Low Density Lipoprotein-bad) Cholesterol level for those individuals utilizing the various combinations of the six supplements during the fifth testing period (ninth month).

LDL (Low Density Lipoprotein - bad) Cholesterol Testing - Month 9

| | | | | | |
|---|---|---|---|---|---|
| A | B | C | D | E | F |
| 156 mg/dl | 160 mg/dl | 196 mg/dl | 160 mg/dl | 194 mg/dl | 194 mg/dl |
| A + C | B + C | C + D | D + E | A + E | C + F |
| 150 mg/dl | 160 mg/dl | 156 mg/dl | 156 mg/dl | 150 mg/dl | NA |
| A + C + E | B + C + E | C + D + E | D + F | B + E | B + F |
| 150 mg/dl | 150 mg/dl | 150 mg/dl | 156 mg/dl | 156 mg/dl | 160 mg/dl |
| A + C + | B + C + | C + D + | D + E + F | E + C | A + F |
| E + F | E + F | E + F | 150 mg/dl | 176 mg/dl | 156 mg/dl |
| 150 mg/dl | 150 mg/dl | 150 mg/dl | | | |
| A + E + F | B + E + F | C + E + F | | | |
| 156 mg/dl | 156 mg/dl | 180 mg/dl | | | |

The sixth testing period (twelfth month) represents the faithful, continuous use of the various nutritional supplements over an extended period of twelve months. This testing period allows comparison to baseline studies as well as each quarterly testing period. It also allows for life style changes as well as diet, weight loss and exercise programs. As previously noted, the addition of the various nutritional supplements has a synergistic effect on the human body. The following is a list of normally observed through application LDL (Low Density Lipoprotein-bad) Cholesterol level for those individuals utilizing the various combinations of the six supplements during the sixth testing period (twelfth month).

LDL (Low Density Lipoprotein - bad) Cholesterol Testing - Month 12

| | | | | | |
|---|---|---|---|---|---|
| A | B | C | D | E | F |
| 156 mg/dl | 160 mg/dl | 196 mg/dl | 160 mg/dl | 194 mg/dl | 194 mg/dl |
| A + C | B + C | C + D | D + E | A + E | C + F |
| 150 mg/dl | 160 mg/dl | 156 mg/dl | 156 mg/dl | 150 mg/dl | NA |
| A + C + E | B + C + E | C + D + E | D + F | B + E | B + F |
| 150 mg/dl | 150 mg/dl | 150 mg/dl | 156 mg/dl | 156 mg/dl | 160 mg/dl |
| A + C + | B + C + | C + D + | D + E + F | E + C | A + F |
| E + F | E + F | E + F | 150 mg/dl | 176 mg/dl | 156 mg/dl |
| 150 mg/dl | 150 mg/dl | 150 mg/dl | | | |
| A + E + F | B + E + F | C + E + F | | | |
| 156 mg/dl | 156 mg/dl | 180 mg/dl | | | |

The following is a list of normally observed through application glucose levels for the individuals utilizing each of the six supplements during the first testing period (1 month).

A) 236 mg/dl

B) 236 mg/dl

C) 251 mg/dl

D) 236 mg/dl

E) 251 mg/dl

F) 280 mg/dl

There is an anticipated synergistic effect when the various supplements are utilized concurrently; therefore, the anticipated hypothetical glucose levels will change as indicated below for the first testing period (1 month).

Glucose Testing - Month 1

| | | | | |
|---|---|---|---|---|
| A + C | A + E | C + E | C + D + E | D + E + F |
| 220 mg/dl | 220 mg/dl | 251 mg/dl | 220 mg/dl | 236 mg/dl |
| B + C | A + F | D + F | A + E + F | A + C + E + F |
| 220 mg/dl | 236 mg/dl | 236 mg/dl | 236 mg/dl | 220 mg/dl |
| C + D | B + E | A + C + E | B + E + F | B + C + E + F |
| 220 mg/dl | 220 mg/dl | 220 mg/dl | 236 mg/dl | 220 mg/dl |
| D + E | B + F | B + C + E | C + E + F | C + D + E + F |
| 236 mg/dl | 236 mg/dl | 220 mg/dl | 220 mg/dl | 220 mg/dl |

The second testing period (second month) reflects the physiological changes in the human body as it adjusts to adequate and appropriate nutritional supplement utilization. As previously noted, the addition of the various nutritional supplements has a synergistic effect on the human body. The following is a list of normally observed through application glucose level for those individuals utilizing the various combinations of the six supplements during the second testing period (second month).

Glucose Testing - Month 2

| | | | | | |
|---|---|---|---|---|---|
| A | B | C | D | E | F |
| 220 mg/dl | 236 mg/dl | 251 mg/dl | 251 mg/dl | 251 mg/dl | 280 mg/dl |
| A + C | B + C | C + D | D + E | A + E | C + F |
| 220 mg/dl | 205 mg/dl | 182 mg/dl | 220 mg/dl | 196 mg/dl | NA |
| A + C + E | B + C + E | C + D + E | D + F | B + E | B + F |
| 220 mg/dl | 182 mg/dl | 220 mg/dl | 220 mg/dl | 205 mg/dl | 220 mg/dl |
| A + C + E + F | B + C + E + F | C + D + E + F | D + E + F | E + C | A + F |
| 182 mg/dl | 182 mg/dl | 182 mg/dl | 196 mg/dl | 251 mg/dl | 220 mg/dl |
| A + E + F | B + E + F | C + E + F | | | |
| 236 mg/dl | 182 mg/dl | 182 mg/dl | | | |

The third testing period (third month) represents the degree of compliance of the individuals utilization of the various supplements as well as the human body's continued adjustment to the appropriate nutritional supplement. As previously noted, the addition of the various nutritional supplements has a synergistic effect on the human body. The following is a list of normally observed through application glucose level for those individuals utilizing the various combinations of the six supplements during the third testing period (third month).

Glucose Testing - Month 3

| | | | | | |
|---|---|---|---|---|---|
| A | B | C | D | E | F |
| 205 mg/dl | 205 mg/dl | 251 mg/dl | 205 mg/dl | 251 mg/dl | 280 mg/dl |
| A + C | B + C | C + D | D + E | A + E | C + F |
| 196 mg/dl | 196 mg/dl | 168 mg/dl | 205 mg/dl | 205 mg/dl | NA |
| A + C + E | B + C + E | C + D + E | D + F | B + E | B + F |
| 168 mg/dl | 168 mg/dl | 168 mg/dl | 205 mg/dl | 196 mg/dl | 205 mg/dl |
| A + C + E + F | B + C + E + F | C + D + E + F | D + E + F | E + C | A + F |
| 168 mg/dl | 168 mg/dl | 168 mg/dl | 168 mg/dl | 236 mg/dl | 205 mg/dl |
| A + E + F | B + E + F | C + E + F | | | |
| 168 mg/dl | 168 mg/dl | 168 mg/dl | | | |

The fourth testing period (sixth month) represents the degree of compliance of the individual's utilization of the various supplements as well as the human body's continued adjustment to the appropriate nutritional supplement. As previously noted, the addition of the various nutritional supplements has a synergistic effect on the human body. The following is a list of normally observed through application glucose level for those individuals utilizing the various combinations of the six supplements during the fourth testing period (sixth month).

Glucose Testing - Month 6

| | | | | | |
|---|---|---|---|---|---|
| A | B | C | D | E | F |
| 196 mg/dl | 196 mg/dl | 251 mg/dl | 196 mg/dl | 251 mg/dl | 280 mg/dl |
| A + C | B + C | C + D | D + E | A + E | C + F |
| 168 mg/dl | 168 mg/dl | 154 mg/dl | 196 mg/dl | 196 mg/dl | NA |
| A + C + E | B + C + E | C + D + E | D + F | B + E | B + F |
| 154 mg/dl | 154 mg/dl | 154 mg/dl | 196 mg/dl | 168 mg/dl | 196 mg/dl |
| A + C + E + F | B + C + E + F | C + D + E + F | D + E + F | E + C | A + F |
| 154 mg/dl | 154 mg/dl | 154 mg/dl | 140 mg/dl | 220 mg/dl | 196 mg/dl |
| A + E + F | B + E + F | C + E + F | | | |
| 140 mg/dl | 140 mg/dl | 154 mg/dl | | | |

The fifth testing period (ninth month) represents the continued degree of compliance of the individual's utilization of the various supplements. This period of testing also reflects the additional effects of weight loss in certain individuals utilizing the supplements for weight loss and the effects of exercise on the human body. As previously noted, the addition of the various nutritional supplements has a synergistic effect on the human body. The following is a list of normally observed through application glucose level for those individuals utilizing the various combinations of the six supplements during the fifth testing period (ninth month).

Glucose Testing - Month 9

| | | | | | |
|---|---|---|---|---|---|
| A | B | C | D | E | F |
| 168 mg/dl | 168 mg/dl | 251 mg/dl | 168 mg/dl | 251 mg/dl | 280 mg/dl |
| A + C | B + C | C + D | D + E | A + E | C + F |
| 168 mg/dl | 168 mg/dl | 140 mg/dl | 140 mg/dl | 154 mg/dl | NA |
| A + C + E | B + C + E | C + D + E | D + F | B + E | B + F |
| 140 mg/dl | 140 mg/dl | 140 mg/dl | 168 mg/dl | 154 mg/dl | 168 mg/dl |
| A + C + E + F | B + C + E + F | C + D + E + F | D + E + F | E + C | A + F |
| 140 mg/dl | 140 mg/dl | 140 mg/dl | 140 mg/dl | 220 mg/dl | 168 mg/dl |
| A + E + F | B + E + F | C + E + F | | | |
| 140 mg/dl | 140 mg/dl | 140 mg/dl | | | |

The sixth testing period (twelfth month) represents the faithful, continuous use of the various nutritional supplements over an extended period of twelve months. This testing period allows comparison to baseline studies as well as each quarterly testing period. It also allows for life style changes as well as diet, weight loss and exercise programs. As previously noted, the addition of the various nutritional supplements has a synergistic effect on the human body. The following is a list of normally observed through application glucose for those individuals utilizing the various combinations of the six supplements during the sixth testing period (twelfth month).

Glucose Testing - Month 12

| | | | | | |
|---|---|---|---|---|---|
| A | B | C | D | E | F |
| 168 mg/dl | 168 mg/dl | 251 mg/dl | 168 mg/dl | 251 mg/dl | 280 mg/dl |
| A + C | B + C | C + D | D + E | A + E | C + F |
| 168 mg/dl | 168 mg/dl | 140 mg/dl | 140 mg/dl | 154 mg/dl | NA |
| A + C + E | B + C + E | C + D + E | D + F | B + E | B + F |
| 140 mg/dl | 140 mg/dl | 140 mg/dl | 168 mg/dl | 154 mg/dl | 168 mg/dl |
| A + C + E + F | B + C + E + F | C + D + E + F | D + E + F | E + C | A + F |
| 140 mg/dl | 140 mg/dl | 140 mg/dl | 140 mg/dl | 220 mg/dl | 168 mg/dl |
| A + E + F | B + E + F | C + E + F | | | |
| 140 mg/dl | 140 mg/dl | 140 mg/dl | | | |

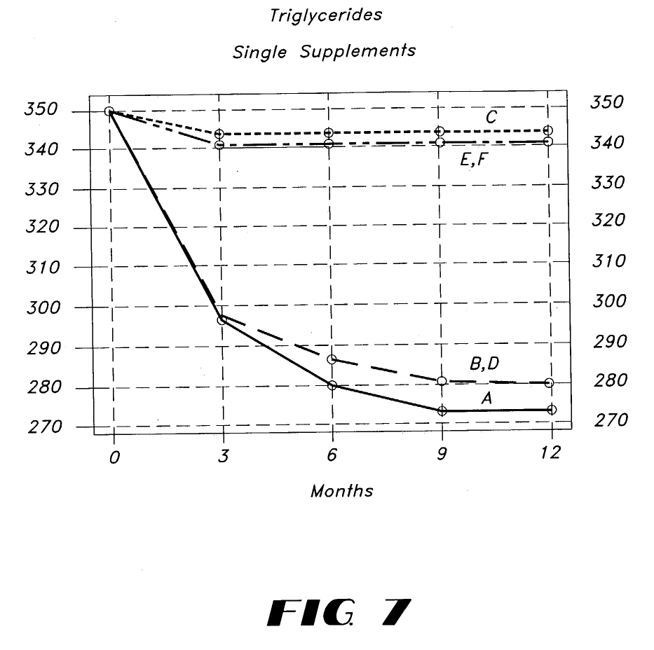

Referring now to FIG. 7A, patients will be randomly assigned a nutritional supplement combination with the following objectives in mind: each nutritional supplement combination will receive a reasonable number of patients and the distributions of the patients within the assigned nutritional supplement combinations will be stratified. That is, each nutritional supplement combination will get a representative sample of patients in the categories of high, medium, and low levels of the components of interest.

The total population of members in the distributor family of the nutritional supplement manufacturer represented is 250,000. Historical data regarding usage of the various nutritional supplements is outlined in Table 1. Table 2 represents the subsets of the distributor family utilizing various combinations of the nutritional supplements produced by this particular manufacturer.

The last assumption is through motivation of the individual to determine the effectiveness of the nutritional supplements he or she is utilizing to effect their life style changes. In addition, the assumption is the nutritional supplement manufacturer will be motivating the individual to assist their company in obtaining data as to the effectiveness of their nutritional supplements. This being the case, the assumption is that five percent of each subset of the distributor family will participate in testing at intervals outlined in Table 3.

A regression model is derived for each nutritional supplement combination and each of the three components of interest based on data from one year, as shown in Table 4.

The final model will be selected using the above major predictors. Other variables included in the database will also be given consideration as predictors for the regression models. These include characteristics such as age, weight, gender, etc. The model utilizing Y4 as the response variable and Y0 as the major predictor variable and the results of the Analysis of Variance in Step 4 will be used to assign the appropriate nutritional supplement combination to a new individual.

Each regression model will be analyzed to determine validity using standard statistical procedures. This will include examination of p-values, F-statistics, t-statistics, coefficients, normality of residuals, R2, appropriateness of model, and criteria for model selection. In the event a regression model is deemed statistically inappropriate, a linear model will be devised using a linear equation calculated from the baseline and 12th month results.

A Two Factor Analysis of Variance (ANOVA) with interaction analyzing decreases in the three components will be completed. The factors in the ANOVA will be Nutritional Supplement Combination and the categories of high, medium, and low. This will indicate which nutritional supplement combinations, if any, are more effective for the specific categories mentioned above. While a particular regression model may perform better overall, a different nutritional supplement combination may provide better results for a specific measurement in one of the three above categories. For example, even though nutritional supplement combination A may perform overall better than nutritional supplement combination B, a person with a glucose level of 220 may get better results using nutritional supplement B. Therefore, data modeling will also be examined for each of the categories within the components.

The ANOVA will be analyzed to determine validity using standard statistical procedures. This will include examination of p-values, F-statistics, and equality of variances. If the ANOVA indicates statistical significance due to categories, models will be developed using both the regression analyses and ANOVA results. In the event the ANOVA indicates that there is no statistical difference in the category results, only the regression models will be used.

After all models are determined, they will be placed in a database that can be used to assign new subjects to the nutritional supplement combination whose model which would provide the optimum benefit. A new subject's baseline information will be evaluated for each model. Each subject would then select a nutritional supplement combination based on the values of the various models. The printout for a new subject will include the third, sixth, ninth, and twelfth month results for each nutritional supplement combination for each of the three quantities being measured. It will also include the model based on the interaction results of the two-factor ANOVA. The twelfth month values will be determined directly from the selected model, while the third, sixth, and ninth month predictions will be calculated from the twelfth month predictions using linear interpolation. Other factors such as allergies can be taken into consideration.

At the beginning of the program, each new subject will have a printout with their individual values according to the nutritional supplement combination selected. This printout will tell them specifically what to expect at certain intervals if they faithfully take their nutritional supplements and adhere to the recommended diet and exercise plan. These values will be based on the aforementioned regression models. At the beginning of each quarter, a person will know what the expected result is for each subsequent quarter based on the results of the previous quarter.

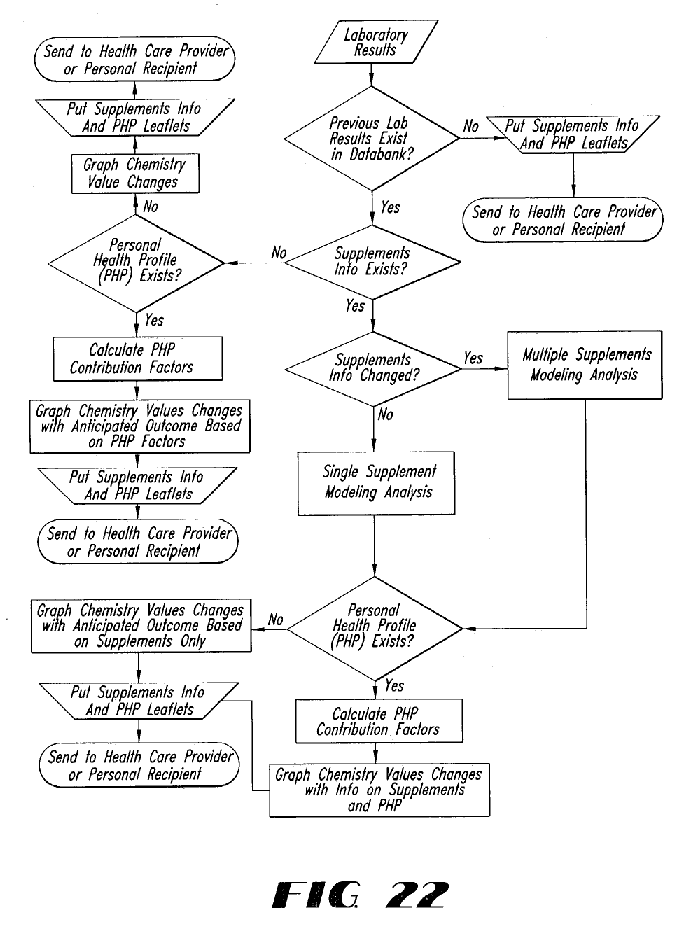

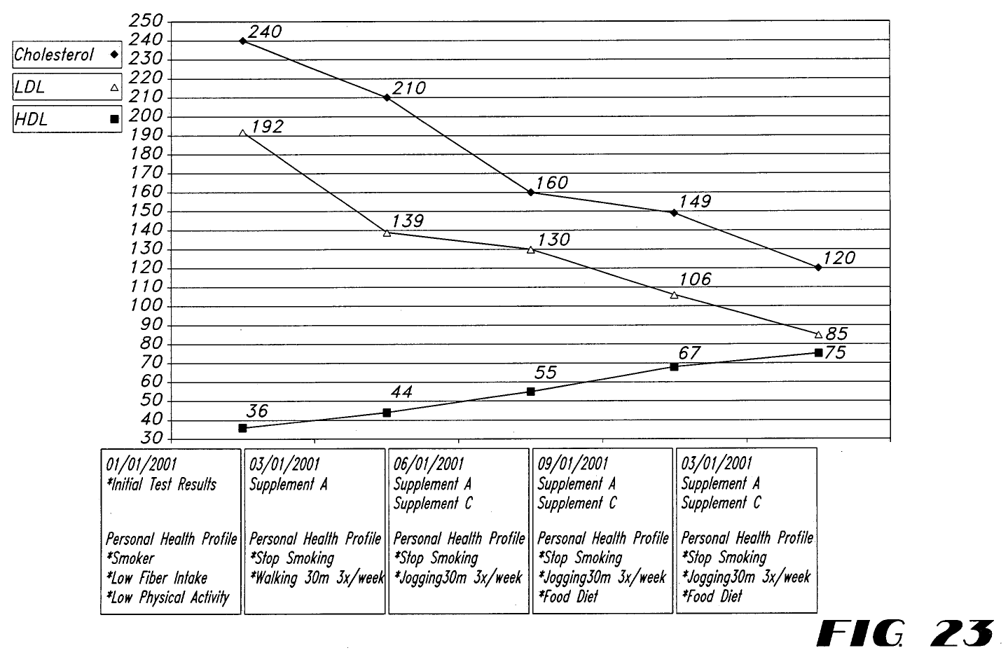

The system further provides a means to chart at least one clinical chemistry value by the designated nutritional supplement and means to chart at least one clinical chemistry value by the personal health profiles. This chart is used to reflect the progression of the changes in the clinical chemistry values in relation with the use of the various nutritional supplements and individual personal health profile. FIGS. 22-25 show flow charts and graphs. Data table 26 provides data graphed in FIG. 23. This flow chart facilitates the production of a graph of clinical chemistry values changes based on PHP or based on supplements and PHP.

These graphs and table of the clinical chemistry values as shown in FIGS. 22-25 will help the consumer to be more aware of the changes that are taking place because of their supplements intakes and personal health profiles modifications. This will help consumers be more proactive and more conscious in maintaining and improving their health in general.

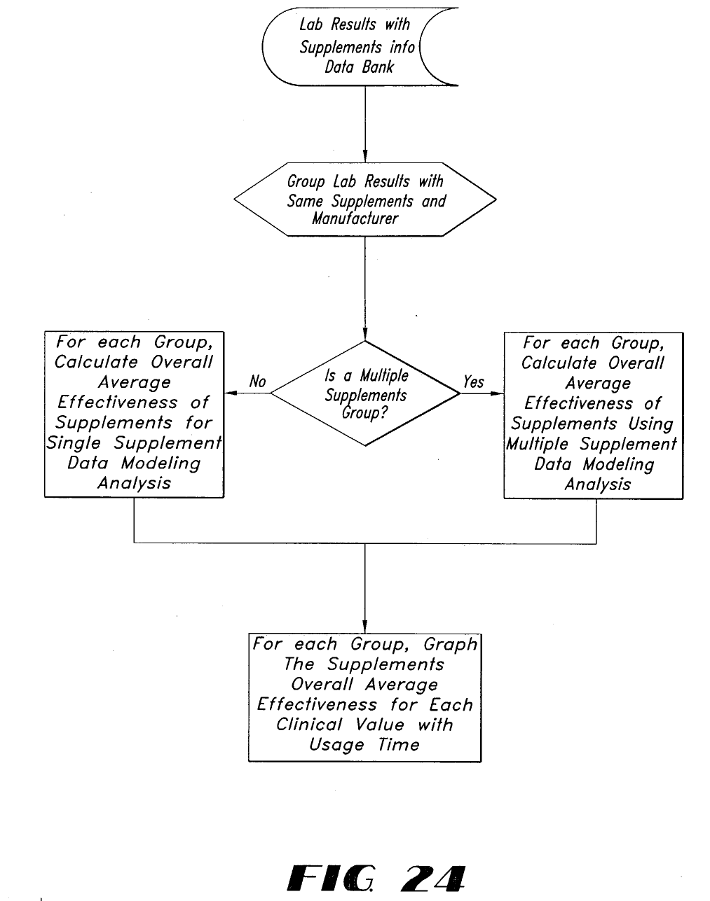

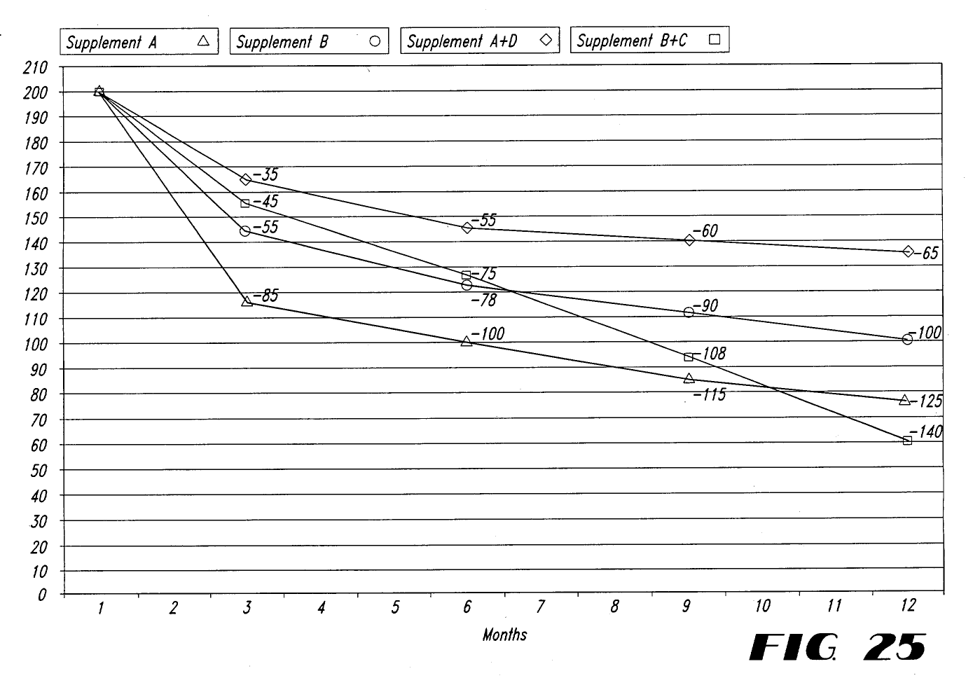

The method as shown in FIGS. 24-25 can be used to validate the consistency of a single supplement or a group of supplements in conjunction with its interaction with a single or a group of clinical chemistry values over a period of time. Based on these processes, the system will be able to establish and verify the claimed benefits of a particular supplement or a group of supplements. The system will be able to produce a graph that plot the benefit of a single supplement or a group of supplements over a period of time, as shown in FIG. 25.

### EXAMPLE 2

A Comparison of the Effectiveness of Nutritional Supplements in Changing Levels of Triglycerides, LDL Cholesterol, and Glucose

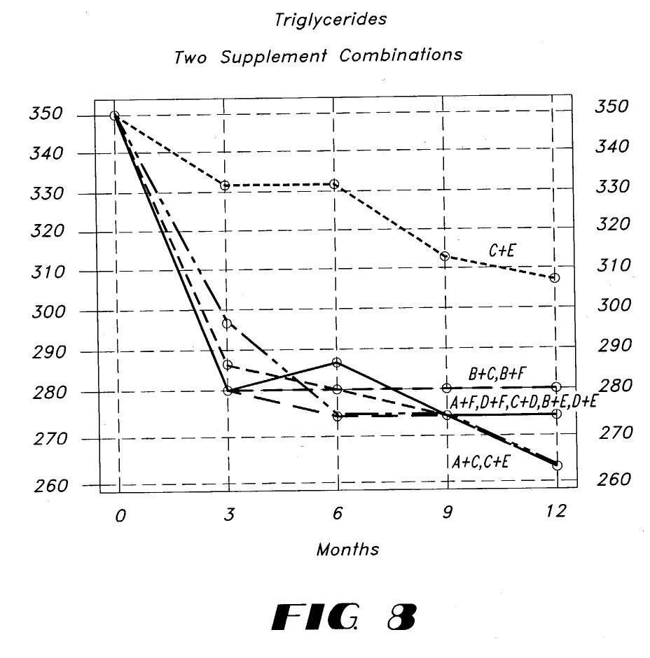

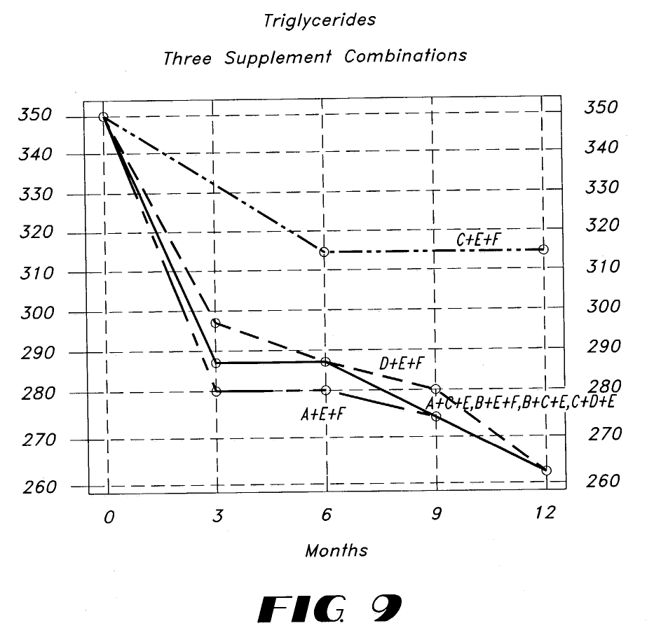

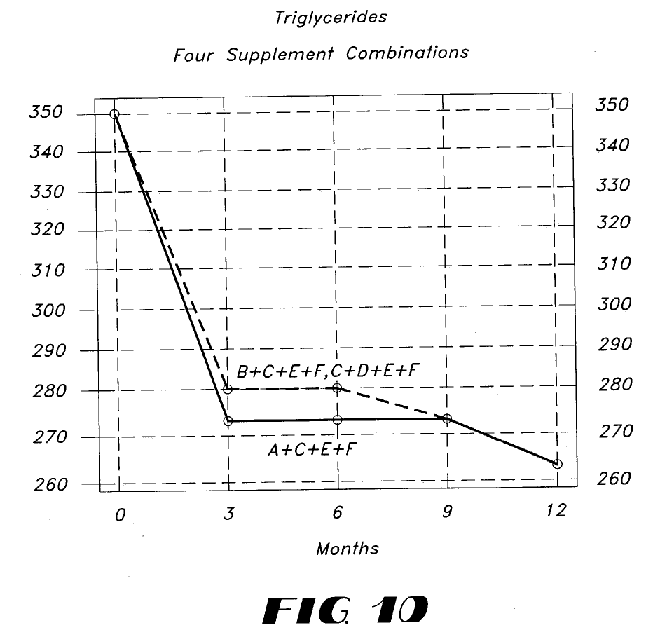

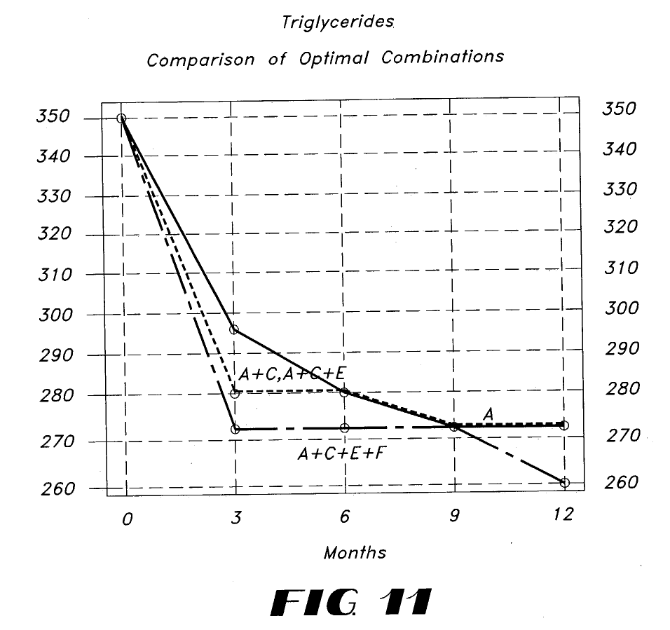

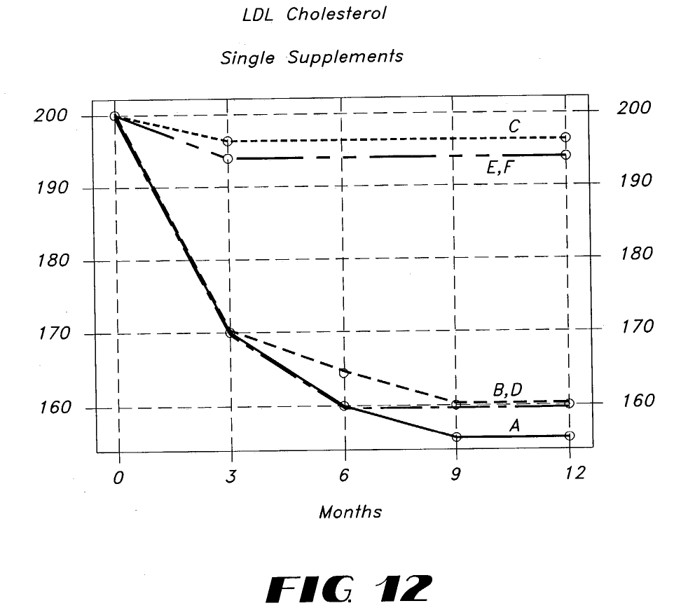

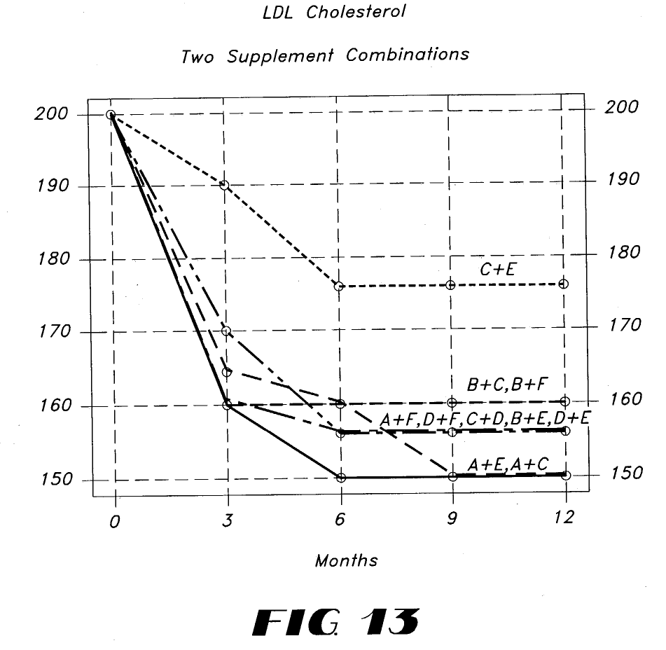

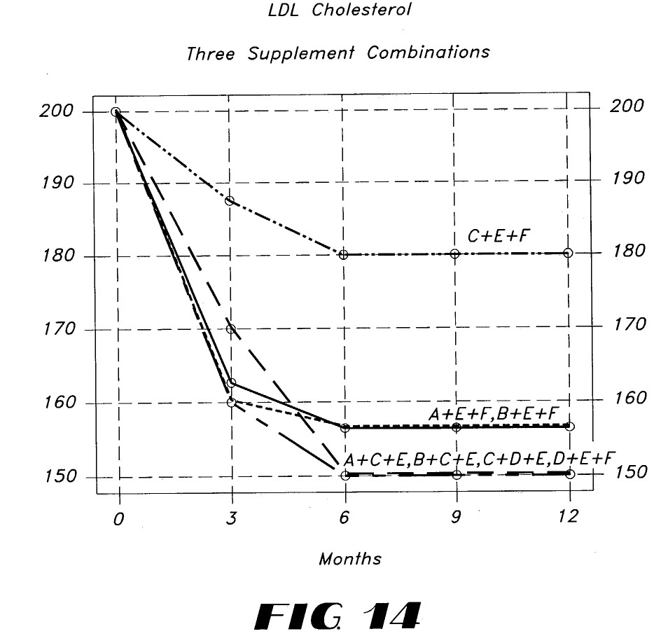

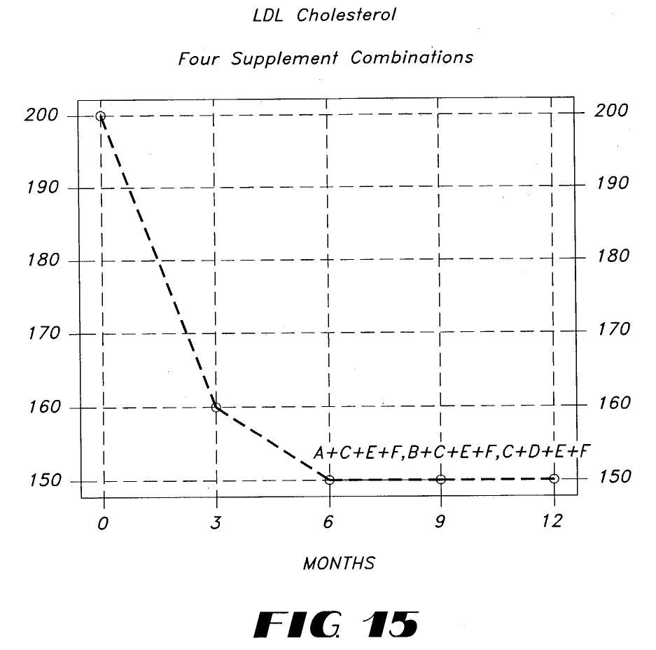

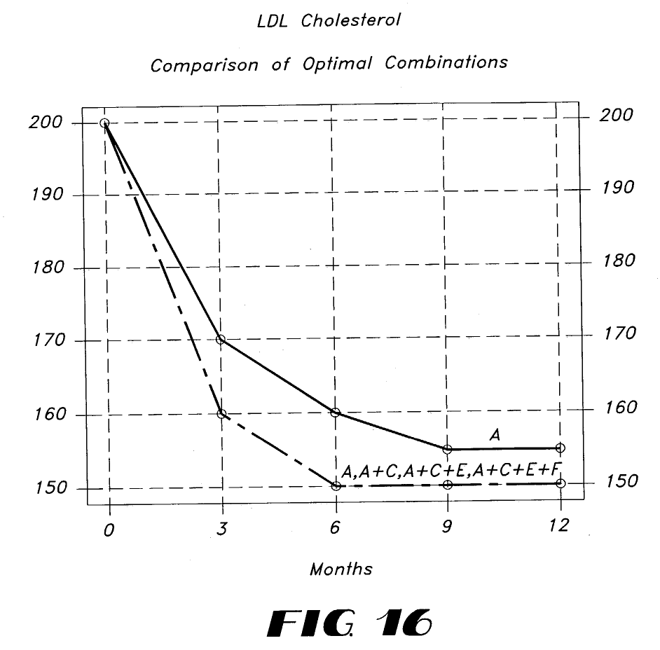

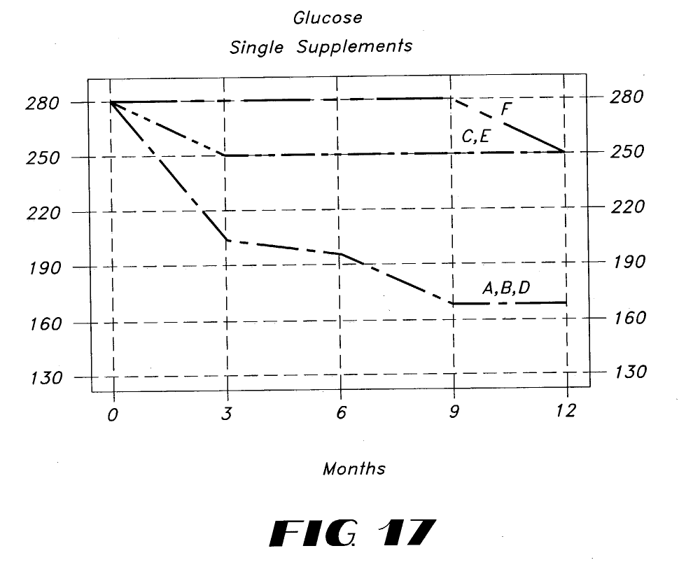

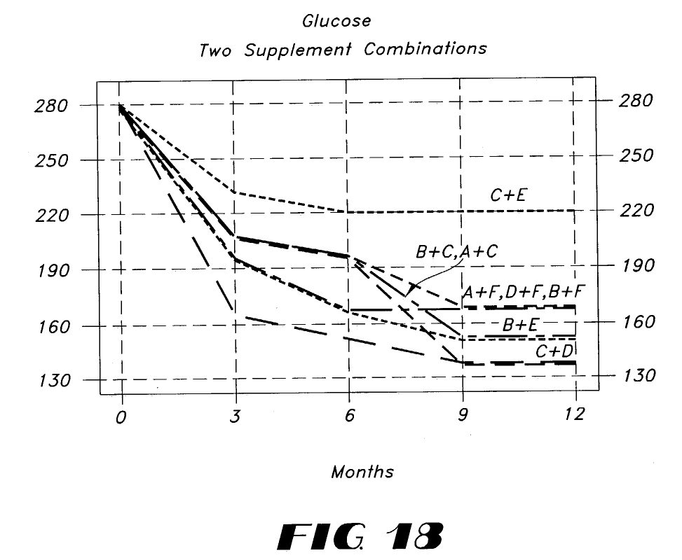

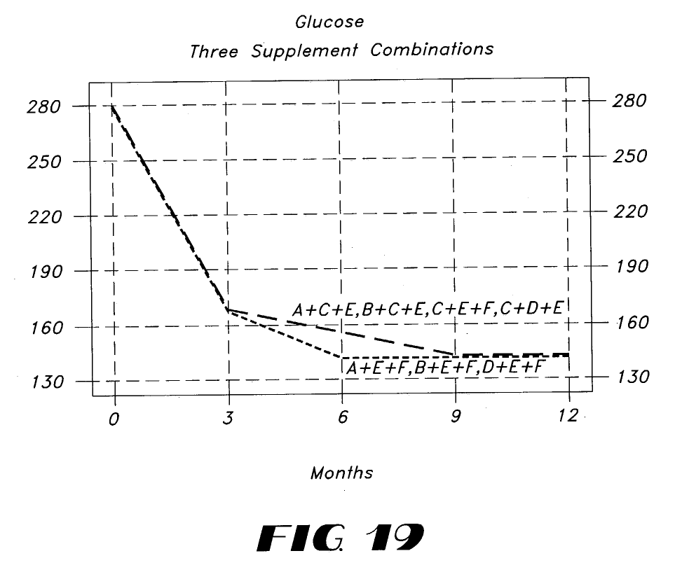

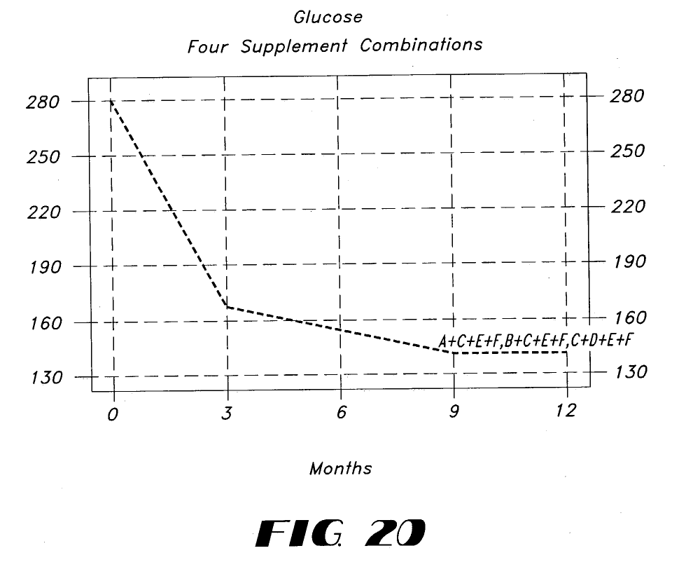

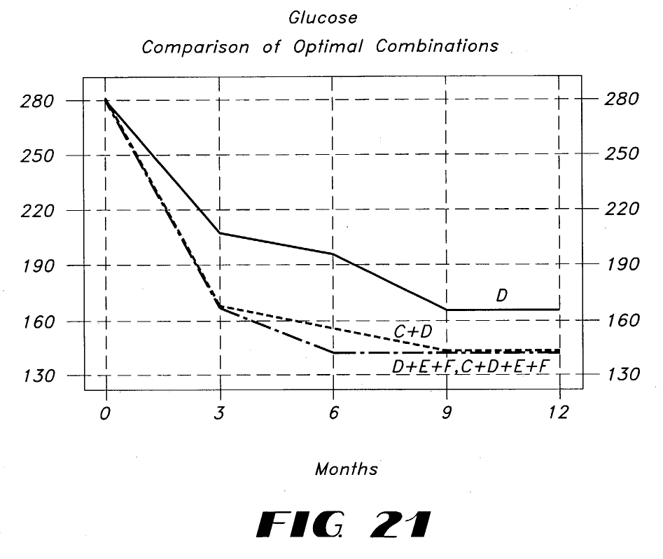

Referring now to FIGS. 8-21 the theoretical results of the changes in Triglycerides, LDL Cholesterol, and Glucose levels using the nutritional supplements listed below as shown. The supplements under consideration are A, B, C, D, E, F, A+C, A+E, C+E, B+C, A+F, D+F, C+D, B+E, D+E, B+F, A+E+F, A+C+E, B+E+F, B+C+E, C+E+F, C+D+E, D+E+F, A+C+E+F, B+C+E+F, and C+D+E+F.

Conclusion: One measure of the overall effectiveness of the various supplement combinations is the total reduction of all three components: Triglycerides, LDL Cholesterol, and Glucose. The system further provides a means to chart at least one clinical chemistry value by the designated nutritional supplement and means to chart at least one clinical chemistry value by the personal health profiles. This chart is used to reflect the progression of the changes in the clinical chemistry values in relation with the use of the various nutritional supplements and individual personal health profile.

Although the foregoing invention has been described in some detail by way of illustration and example for purposes of clarity of understanding, it will be obvious that certain changes and modifications may be practiced within the scope of the appended claims.

TABLE 1
Company Rejuvenate

| | |
|---|---|
| Total Distributors: | 250,000 |
| Distributors utilizing: | |
| A) Original | 100,000 |
| B) Restore | 100,000 |
| C) Energy | 225,000 |
| D) Ultradiet | 50,000 |
| E) Enzyme Therapy | 37,000 |
| F) Fiber Therapy | 25,000 |

A-F represent nutritional supplements that could be designated by a consumer on the order form.

TABLE 2
Supplementation Utilization

| | | | | | |
|---|---|---|---|---|---|
| A | B | C | D | E | F |
| A + C | B + C | C + D | D + E | A + E | C + F |
| A + C + E | B + C + E | C + D + E | D + F | B + E | B + F |
| A + C + E + F | B + C + E + F | C + D + | D + E + | E + C | A + F |
| | | E + F | F | | |
| A + E + F | B + E + F | C + E + F | | | |

TABLE 3
Progressive Steps in Lifestyle Changes

| Fluid Sample | | | |
|---|---|---|---|
| Retrieval | | | |
| System | Interval | | |
| Purchase | Proceeding | Action | Notes |
| 1^{st} | | Start Nutritional Supplement. | Maintain present diet. |
| | | Initiate Data Bank | Maintain present exercise |
| | | | level. Do not change |
| | | | lifestyle. |
| 2^{nd} | 1 month | Do not alter dose or | Reinforce appropriate use of |
| | | combination of supplements. | supplements. No change in |
| | | Update data | lifestyle, diet, or exercise. |
| 3^{rd} | 2 months | Record symptomatic | Encourage compliance with |
| | | improvement in patient’s | overall program of |
| | | condition. Update data. | nutritional supplements. No |
| | | Begin comparison to | change in lifestyle, diet, or |
| | | baseline studies. | exercise. |
| 4^{th} | 3 months | Update data. Compare to | Stress compliance. No |
| | | baseline studies. | change in lifestyle. |
| 5^{th} | 6 months | Update data. Compare to | Stress compliance. Maintain |
| | | baseline studies. Add | same diet. Increase exercise |
| | | exercise. | level. |
| 6^{th} | 9 months | Update data. Continue | Stress compliance |
| | | comparison to baseline | Increase exercise level |
| | | studies and to 6^{th} month data | |
| 7^{th} | 12 months | Compare to baseline and | Stress compliance. |
| | | quarterly testing. Complete | Encourage weight loss. |
| | | analysis for change in | Decrease dietary intake of |
| | | cholesterol, triglyceride, | saturated fat and cholesterol |
| | | HDL, LDL, and fluid | Continue exercise program |
| | | glucose. | |

TABLE 4

| | |
|---|---|
| (a) | The components to be measured are |
| | LDL Cholesterol |
| | Triglycerides |
| | Glucose |
| (b) | Use the following variable assignments: |
| | Y0 = baseline measure |
| | Y1 = Third month results |
| | Y2 = Sixth month results |
| | Y3 = Ninth month results |
| | Y4 = Twelfth month results |
| (c) | The following regression models will be determined: |

| Response | Major Predictor(s) |
|---|---|
| Y1 | Y0 |
| Y2 | Y0, Y1 |
| Y3 | Y0, Y1, Y2 |
| Y4 | Y0, Y1, Y2, Y3 |
| Y4 | Y0 |

TABLE 5

| Time | | |
|---|---|---|
| 0 | 3^{rd}, 6^{th}, 9^{th}, 12^{th} months | Baseline |
| 3^{rd} month | 6^{th}, 9^{th}, 12^{th} months | Baseline, 3^{rd} month |
| 6^{th} month | 9^{th}, 12^{th} months | Baseline, 3^{rd}, 6^{th} months |
| 9^{th} month | 12^{th} month | Baseline, 3^{rd}, 6^{th}, 9^{th} months |

After one full year of the program is completed, a subject's information will be added to the overall database.

These steps will be repeated continually as new subjects enter the program.

TABLE 6

| | | LDL | | | |
|---|---|---|---|---|---|
| | | Triglycerides | Cholesterol | Glucose | Total |
| Single Supplement | A | 77 | 44 | 112 | 233 |
| Two Supplement Combinations | A + E | 88 | 50 | 126 | 264 |
| Three Supplement Combinations | A + C + E | 88 | 50 | 140 | 278 |
| | B + C + E | 88 | 50 | 140 | 278 |
| | C + D + E | 88 | 50 | 140 | 278 |
| | D + E + F | 88 | 50 | 40 | 278 |
| Four Supplement Combinations | A + C + E + F | 88 | 50 | 140 | 278 |
| | B + C + E + F | 88 | 50 | 140 | 278 |
| | C + D + E + F | 88 | 50 | 140 | 278 |

TABLE 7
Triglycerides - All Supplement Combinations

| | Month | | | | | |
|---|---|---|---|---|---|---|
| Supplement(s) | 0 | 3 | 6 | 9 | 12 | 12 month decrease |
| A | 350 | 297 | 280 | 273 | 273 | 77** |
| B | 350 | 297 | 287 | 280 | 280 | 70 |
| C | 350 | 343 | 343 | 343 | 343 | 7 |
| D | 350 | 297 | 287 | 280 | 280 | 70 |
| E | 350 | 341 | 341 | 341 | 341 | 9 |
| F | 350 | 341 | 341 | 341 | 341 | 9 |
| A + C | 350 | 280 | 280 | 273 | 262 | 88** |
| A + E | 350 | 287 | 280 | 273 | 262 | 88* |
| C + E | 350 | 332 | 332 | 315 | 308 | 42 |
| B + C | 350 | 280 | 280 | 280 | 280 | 70 |
| A + F | 350 | 297 | 273 | 273 | 273 | 77 |
| D + F | 350 | 280 | 280 | 273 | 273 | 77 |
| C + D | 350 | 280 | 280 | 273 | 273 | 77 |
| B + E | 350 | 280 | 273 | 273 | 273 | 77 |
| D + E | 350 | 280 | 287 | 273 | 273 | 77 |
| B + F | 350 | 280 | 280 | 280 | 280 | 70 |
| A + E + F | 350 | 287 | 287 | 273 | 262 | 88* |
| A + C + E | 350 | 280 | 280 | 273 | 262 | 88** |
| B + E + F | 350 | 280 | 280 | 273 | 262 | 88** |
| B + C + E | 350 | 280 | 280 | 273 | 262 | 88** |
| C + E + F | 350 | 329 | 315 | 315 | 315 | 35 |
| C + D + E | 350 | 280 | 280 | 273 | 262 | 88** |
| D + E + F | 350 | 297 | 287 | 280 | 262 | 88* |
| A + C + E + F | 350 | 273 | 273 | 273 | 262 | 88** |
| B + C + E + F | 350 | 280 | 280 | 273 | 262 | 88* |
| C + D + E + F | 350 | 280 | 280 | 273 | 262 | 88* |

Maximum Twelve Month Decrease for Category*
Optimal Individual Combinations for Category**

TABLE 8
Triglycerides - Single Supplements

| | Month | | | | | |
|---|---|---|---|---|---|---|
| Supplement(s) | 0 | 3 | 6 | 9 | 12 | 12 month decrease |
| A | 350 | 297 | 280 | 273 | 273 | 77** |
| B | 350 | 297 | 287 | 280 | 280 | 70 |
| C | 350 | 343 | 343 | 343 | 343 | 7 |
| D | 350 | 297 | 287 | 280 | 280 | 70 |
| E | 350 | 341 | 341 | 341 | 341 | 9 |
| F | 350 | 341 | 341 | 341 | 341 | 9 |

Maximum twelve month decrease for category*
Optimal Individual Combinations for category**

TABLE 9
Triglycerides - Two Supplement Combinations

| | Month | | | | | |
|---|---|---|---|---|---|---|
| Supplement(s) | 0 | 3 | 6 | 9 | 12 | 12 month decrease |
| A + C | 350 | 280 | 280 | 273 | 262 | 88** |
| A + E | 350 | 287 | 280 | 273 | 262 | 88* |
| C + E | 350 | 332 | 332 | 315 | 308 | 42 |
| B + C | 350 | 280 | 280 | 280 | 280 | 70 |
| A + F | 350 | 297 | 273 | 273 | 273 | 77 |
| D + F | 350 | 280 | 280 | 273 | 273 | 77 |
| C + D | 350 | 280 | 280 | 273 | 273 | 77 |
| B + E | 350 | 280 | 273 | 273 | 273 | 77 |
| D + E | 350 | 280 | 287 | 273 | 273 | 77 |
| B + F | 350 | 280 | 280 | 280 | 280 | 70 |

Maximum twelve month decrease for category*
Optimal Combination(s) for category**

TABLE 10
Triglycerides - Three Supplement Combinations

| | Month | | | | | |
|---|---|---|---|---|---|---|
| Supplement(s) | 0 | 3 | 6 | 9 | 12 | 12 month decrease |
| A + E + F | 350 | 287 | 287 | 273 | 262 | 88* |
| A + C + E | 350 | 280 | 280 | 273 | 262 | 88** |
| B + E + F | 350 | 280 | 280 | 273 | 262 | 88** |
| B + C + E | 350 | 280 | 280 | 273 | 262 | 88** |
| C + E + F | 350 | 329 | 315 | 315 | 315 | 35 |
| C + D + E | 350 | 280 | 280 | 273 | 262 | 88** |
| D + E + F | 350 | 297 | 287 | 280 | 262 | 88* |

Maximum twelve month decrease for category*
Optimal Combination(s) for category**

TABLE 11
Triglycerides - Four Supplement Combinations

| | Month | | | | | |
|---|---|---|---|---|---|---|
| Supplement(s) | 0 | 3 | 6 | 9 | 12 | 12 month decrease |
| A + C + E + F | 350 | 273 | 273 | 273 | 262 | 88** |
| B + C + E + F | 350 | 280 | 280 | 273 | 262 | 88* |
| C + D + E + F | 350 | 280 | 280 | 273 | 262 | 88* |

Maximum twelve month decrease for category*
Optimal Combination(s) for category**

TABLE 12
Triglycerides - Comparison of Optimal Combinations

| | Month | | | | | |
|---|---|---|---|---|---|---|
| Supplement(s) | 0 | 3 | 6 | 9 | 12 | 12 month decrease |
| A | 350 | 297 | 280 | 273 | 273 | 77 |
| A + C | 350 | 280 | 280 | 273 | 262 | 88* |
| A + C + E | 350 | 280 | 280 | 273 | 262 | 88* |
| A + C + E + F | 350 | 273 | 273 | 273 | 262 | 88** |

Maximum twelve month decrease*
Optimal Combination(s)**

TABLE 13
LDL Cholesterol - All Supplement Combinations

| | Month | | | | | |
|---|---|---|---|---|---|---|
| Supplement(s) | 0 | 3 | 6 | 9 | 12 | 12 month decrease |
| A | 200 | 170 | 160 | 156 | 156 | 44** |
| B | 200 | 170 | 164 | 160 | 160 | 40 |
| C | 200 | 196 | 196 | 196 | 196 | 4 |
| D | 200 | 170 | 160 | 160 | 160 | 40 |
| E | 200 | 194 | 194 | 194 | 194 | 6 |
| F | 200 | 194 | 194 | 194 | 194 | 6 |
| A + C | 200 | 160 | 150 | 150 | 150 | 50** |
| A + E | 200 | 164 | 160 | 150 | 150 | 50* |
| C + E | 200 | 190 | 176 | 176 | 176 | 24 |
| B + C | 200 | 160 | 160 | 160 | 160 | 40 |
| A + F | 200 | 170 | 156 | 156 | 156 | 44 |
| D + F | 200 | 160 | 156 | 156 | 156 | 44 |
| C + D | 200 | 160 | 156 | 156 | 156 | 44 |
| B + E | 200 | 160 | 156 | 156 | 156 | 44 |
| D + E | 200 | 160 | 156 | 156 | 156 | 44 |
| B + F | 200 | 160 | 160 | 160 | 160 | 40 |
| A + E + F | 200 | 164 | 156 | 156 | 156 | 44 |
| A + C + E | 200 | 160 | 150 | 150 | 150 | 50** |
| B + E + F | 200 | 160 | 156 | 156 | 156 | 44 |
| B + C + E | 200 | 160 | 150 | 150 | 150 | 50** |
| C + E + F | 200 | 188 | 180 | 180 | 180 | 20 |
| C + D + E | 200 | 160 | 150 | 150 | 150 | 50** |
| D + E + F | 200 | 170 | 150 | 150 | 150 | 50* |
| A + C + E + F | 200 | 160 | 150 | 150 | 150 | 50** |
| B + C + E + F | 200 | 160 | 150 | 150 | 150 | 50** |
| C + D + E + F | 200 | 160 | 150 | 150 | 150 | 50** |

Maximum twelve month decrease for category*
Optimal Combination(s) for category**

TABLE 14
LDL Cholesterol - Single Supplements

| | Month | | | | | |
|---|---|---|---|---|---|---|
| Supplement(s) | 0 | 3 | 6 | 9 | 12 | 12 month decrease |
| A | 200 | 170 | 160 | 156 | 156 | 44** |
| B | 200 | 170 | 164 | 160 | 160 | 40 |
| C | 200 | 196 | 196 | 196 | 196 | 4 |
| D | 200 | 170 | 160 | 160 | 160 | 40 |
| E | 200 | 194 | 194 | 194 | 194 | 6 |
| F | 200 | 194 | 194 | 194 | 194 | 6 |

Maximum twelve month decrease for category*
Optimal Combination(s) for category**

TABLE 15
LDL Cholesterol - Two Supplement Combinations

| | Month | | | | | |
|---|---|---|---|---|---|---|
| Supplement(s) | 0 | 3 | 6 | 9 | 12 | 12 month decrease |
| A + C | 200 | 160 | 150 | 150 | 150 | 50** |
| A + E | 200 | 164 | 160 | 150 | 150 | 50* |
| C + E | 200 | 190 | 176 | 176 | 176 | 24 |
| B + C | 200 | 160 | 160 | 160 | 160 | 40 |
| A + F | 200 | 170 | 156 | 156 | 156 | 44 |
| D + F | 200 | 160 | 156 | 156 | 156 | 44 |
| C + D | 200 | 160 | 156 | 156 | 156 | 44 |
| B + E | 200 | 160 | 156 | 156 | 156 | 44 |
| D + E | 200 | 160 | 156 | 156 | 156 | 44 |
| B + F | 200 | 160 | 160 | 160 | 160 | 40 |

Maximum twelve month decrease for category*
Optimal Combination(s) for category**

TABLE 16
LDL Cholesterol - Three Supplement Combinations

| | Month | | | | | |
|---|---|---|---|---|---|---|
| Supplement(s) | 0 | 3 | 6 | 9 | 12 | 12 month decrease |
| A + E + F | 200 | 164 | 156 | 156 | 156 | 44 |
| A + C + E | 200 | 160 | 150 | 150 | 150 | 50** |
| B + E + F | 200 | 160 | 156 | 156 | 156 | 44 |
| B + C + E | 200 | 160 | 150 | 150 | 150 | 50** |
| C + E + F | 200 | 188 | 180 | 180 | 180 | 20 |
| C + D + E | 200 | 160 | 150 | 150 | 150 | 50** |
| D + E + F | 200 | 170 | 150 | 150 | 150 | 50* |

Maximum twelve month decrease for category*
Optimal Combination(s) for category**

TABLE 17
LDL Cholesterol - Four Supplement Combinations

| | Month | | | | | |
|---|---|---|---|---|---|---|
| Supplement(s) | 0 | 3 | 6 | 9 | 12 | 12 month decrease |
| A + C + E + F | 200 | 160 | 150 | 150 | 150 | 50** |
| B + C + E + F | 200 | 160 | 150 | 150 | 150 | 50** |
| C + D + E + F | 200 | 160 | 150 | 150 | 150 | 50** |

Maximum twelve month decrease for category*
Optimal Combination(s) for category**

TABLE 18
LDL Cholesterol - Comparison of Optimal Combinations

| | Month | | | | | |
|---|---|---|---|---|---|---|
| Supplement(s) | 0 | 3 | 6 | 9 | 12 | 12 month decrease |
| A | 200 | 170 | 160 | 156 | 156 | 44 |
| A + C | 200 | 160 | 150 | 150 | 150 | 50** |
| A + C + E | 200 | 160 | 150 | 150 | 150 | 50** |
| A + C + E + F | 200 | 160 | 150 | 150 | 150 | 50** |

Maximum twelve month decrease*
Optimal Combination(s)**

TABLE 19
Glucose - All Supplement Combinations

| | Month | | | | | |
|---|---|---|---|---|---|---|
| Supplement(s) | 0 | 3 | 6 | 9 | 12 | 12 month decrease |
| A | 280 | 205 | 196 | 168 | 168 | 112** |
| B | 280 | 205 | 196 | 168 | 168 | 112** |
| C | 280 | 251 | 251 | 251 | 251 | 29 |
| D | 280 | 205 | 196 | 168 | 168 | 112** |
| E | 280 | 251 | 251 | 251 | 251 | 29 |
| F | 280 | 280 | 280 | 280 | 251 | 29 |
| A + C | 280 | 196 | 168 | 168 | 168 | 112 |
| A + E | 280 | 205 | 196 | 154 | 154 | 126 |
| C + E | 280 | 236 | 220 | 220 | 220 | 60 |
| B + C | 280 | 196 | 168 | 168 | 168 | 112 |
| A + F | 280 | 205 | 196 | 168 | 168 | 112 |
| D + F | 280 | 205 | 196 | 168 | 168 | 112 |
| C + D | 280 | 168 | 154 | 140 | 140 | 140** |
| B + E | 280 | 196 | 168 | 154 | 154 | 126 |
| D + E | 280 | 205 | 196 | 140 | 140 | 140* |
| B + F | 280 | 205 | 196 | 168 | 168 | 112 |
| A + E + F | 280 | 168 | 140 | 140 | 140 | 140* |
| A + C + E | 280 | 168 | 154 | 140 | 140 | 140* |
| B + E + F | 280 | 168 | 140 | 140 | 140 | 140** |
| B + C + E | 280 | 168 | 154 | 140 | 140 | 140* |
| C + E + F | 280 | 168 | 154 | 140 | 140 | 140* |
| C + D + E | 280 | 168 | 154 | 140 | 140 | 140* |
| D + E + F | 280 | 168 | 140 | 140 | 140 | 140** |
| A + C + E + F | 280 | 168 | 154 | 140 | 140 | 140** |
| B + C + E + F | 280 | 168 | 154 | 140 | 140 | 140** |
| C + D + E + F | 280 | 168 | 154 | 140 | 140 | 140** |

Maximum twelve month decrease for category*
Optimal Combination(s) for category**

TABLE 20
Glucose - Single Supplements

| | Month | | | | | |
|---|---|---|---|---|---|---|
| Supplement(s) | 0 | 3 | 6 | 9 | 12 | 12 month decrease |
| A | 280 | 205 | 196 | 168 | 168 | 112** |
| B | 280 | 205 | 196 | 168 | 168 | 112** |
| C | 280 | 251 | 251 | 251 | 251 | 29 |
| D | 280 | 205 | 196 | 168 | 168 | 112** |
| E | 280 | 251 | 251 | 251 | 251 | 29 |
| F | 280 | 280 | 280 | 280 | 251 | 29 |

Maximum twelve month decrease for category*
Optimal Combination(s) for category**

TABLE 21
Glucose Two Supplement Combinations

| | Month | | | | | |
|---|---|---|---|---|---|---|
| Supplement(s) | 0 | 3 | 6 | 9 | 12 | 12 month decrease |
| A + C | 280 | 196 | 168 | 168 | 168 | 112 |
| A + E | 280 | 205 | 196 | 154 | 154 | 126 |
| C + E | 280 | 236 | 220 | 220 | 220 | 60 |
| B + C | 280 | 196 | 168 | 168 | 168 | 112 |
| A + F | 280 | 205 | 196 | 168 | 168 | 112 |
| D + F | 280 | 205 | 196 | 168 | 168 | 112 |
| C + D | 280 | 168 | 154 | 140 | 140 | 140** |
| B + E | 280 | 196 | 168 | 154 | 154 | 126 |
| D + E | 280 | 205 | 196 | 140 | 140 | 140* |
| B + F | 280 | 205 | 196 | 168 | 168 | 112 |

Maximum twelve month decrease for category*
Optimal Combination(s) for category**

TABLE 22
Glucose - All Supplement Combinations

| | Month | | | | | |
|---|---|---|---|---|---|---|
| Supplement(s) | 0 | 3 | 6 | 9 | 12 | 12 month decrease |
| A + E + F | 280 | 168 | 140 | 140 | 140 | 140* |
| A + C + E | 280 | 168 | 154 | 140 | 140 | 140* |
| B + E + F | 280 | 168 | 140 | 140 | 140 | 140** |
| B + C + E | 280 | 168 | 154 | 140 | 140 | 140* |
| C + E + F | 280 | 168 | 154 | 140 | 140 | 140* |
| C + D + E | 280 | 168 | 154 | 140 | 140 | 140* |
| D + E + F | 280 | 168 | 140 | 140 | 140 | 140** |

Maximum twelve month decrease for category*
Optimal Combination(s) for category**

TABLE 23
Glucose - All Supplement Combinations

| | Month | | | | | |
|---|---|---|---|---|---|---|
| Supplement(s) | 0 | 3 | 6 | 9 | 12 | 12 month decrease |
| A + C + E + F | 280 | 168 | 154 | 140 | 140 | 140** |
| B + C + E + F | 280 | 168 | 154 | 140 | 140 | 140** |
| C + D + E + F | 280 | 168 | 154 | 140 | 140 | 140** |

Maximum twelve month decrease*
Optimal Combination(s)**

TABLE 24
Glucose - Comparison of Optimal Combinations

| | Month | | | | | |
|---|---|---|---|---|---|---|
| Supplement(s) | 0 | 3 | 6 | 9 | 12 | 12 month decrease |
| D | 280 | 205 | 196 | 168 | 168 | 112** |
| D + E | 280 | 205 | 196 | 140 | 140 | 140* |
| D + E + F | 280 | 168 | 140 | 140 | 140 | 140** |
| C + D + E + F | 280 | 168 | 154 | 140 | 140 | 140** |

Maximum twelve month decrease*
Optimal Combination(s)**

TABLE 25
Combined 12 Month Total Decrease for Triglycerides,
LDL Cholesterol, and Glucose

| | | LDL | | |
|---|---|---|---|---|
| Supplement(s) | Triglycerides | Cholesterol | Glucose | Total |
| A | 77 | 44 | 112 | 233** |
| B | 70 | 40 | 112 | 222 |
| C | 7 | 4 | 29 | 40 |
| D | 70 | 40 | 112 | 222 |
| E | 9 | 6 | 29 | 44 |
| F | 9 | 6 | 29 | 44 |
| A + C | 88 | 50 | 112 | 250 |
| A + E | 88 | 50 | 126 | 264** |
| C + E | 42 | 24 | 60 | 126 |
| B + C | 70 | 40 | 112 | 222 |
| A + F | 77 | 44 | 112 | 233 |
| D + F | 77 | 44 | 112 | 233 |
| C + D | 77 | 44 | 140 | 261 |
| B + E | 77 | 44 | 126 | 247 |
| D + E | 77 | 44 | 140 | 261 |
| B + F | 70 | 40 | 112 | 222 |
| A + E + F | 88 | 44 | 140 | 272 |
| A + C + E | 88 | 50 | 140 | 278*** |
| B + E + F | 88 | 44 | 140 | 272 |
| B + C + E | 88 | 50 | 140 | 278*** |
| C + E + F | 35 | 20 | 140 | 195 |
| C + D + E | 88 | 50 | 140 | 278*** |
| D + E + F | 88 | 50 | 140 | 278*** |
| A + C + E + F | 88 | 50 | 140 | 278*** |
| B + C + E + F | 88 | 50 | 140 | 278*** |
| C + D + E + F | 88 | 50 | 140 | 278*** |

Optimal Individual Combinations for category totals**
Optimal Overall Combination(s) for all category totals***

TABLE 26

| | Jan. 1, 2001 | Mar. 1, 2001 | Jun. 1, 2001 | Sep. 1, 2001 | Dec. 1, 2001 | Normal Range | |
|---|---|---|---|---|---|---|---|
| Glucose | 105 | 96 | 90 | 87 | 85 | 65-105 | mg/dL |
| BUN | 20 | 21 | 21 | 21 | 21 | 7-18 | mg/Dl |
| Creatinine | 1.4 | 1.3 | 1.1 | 1.1 | 1.1 | 0.5-1.2 | mg/dL |
| Sodium | 137 | 136 | 136 | 136 | 136 | 136-146 | mEq/L |
| K + | 4.6 | 4.7 | 4.5 | 4.6 | 4.6 | 3.5-5.5 | mEq/L |
| Chloride | 102 | 102 | 102 | 102 | 103 | 98-107 | mEq/L |
| Calcium | 9.4 | 9.2 | 9.6 | 9.5 | 9.5 | 8.4-10.2 | mg/L |
| Phosphorous | 3.1 | 2.9 | 3.0 | 3.2 | 3.2 | 2.8-4.1 | mg/dL |
| Cholesterol | 240 | 210 | 160 | 149 | 120 | <200 | mg/dL |
| Triglyceride | 197 | 189 | 203 | 203 | 202 | <150 | mg/dL |
| HDL | 36 | 44 | 55 | 67 | 75 | 40-60 | mg/dL |
| LDL | 192 | 139 | 130 | 106 | 98 | <99 | mg/dL |
| Uric Acid | 6.9 | 7.0 | 7.0 | 7.0 | 7.0 | 2.5-7.5 | mg/dL |
| Total Protein | 7.6 | 7.1 | 7.4 | 7.4 | 7.4 | 6.3-8.2 | g/dL |
| Albumin | 4.6 | 4.5 | 4.5 | 4.5 | 4.5 | 3.4-51 | gm/dL |
| Globulin | 3 | 2.8 | 2.9 | 2.9 | 2.9 | 2.3-3.5 | gm/dL |
| A/G Ratio | 1.5 | 1.5 | 1.5 | 1.5 | 1.5 | 1.1-1.8 | |
| AST (SGOT) | 32 | 34 | 34 | 34 | 34 | 8-39 | IU/L |
| ALT (SGPT) | 58 | 60 | 57 | 56 | 54 | 9-52 | units/L |
| LDH | 448 | 442 | 438 | 437 | 439 | 313-618 | mg/dL |
| Alkaline Phos | 67 | 66 | 72 | 70 | 71 | 38-126 | IU/L |
| GGT | 80 | 77 | 71 | 65 | 69 | 12-43 | units/L |
| Total Bilirubin | 0.4 | 0.4 | 0.3 | 0.3 | 0.2 | 0.2-1.3 | mg/dL |
| Dir Bilirubin | 0 | 0 | 0 | 0 | 0.2 | <0.5 | mg/dL |
| Indir Bilirubin | 0.4 | 0.4 | 0.3 | 0.3 | 0.1 | <0.8 | mg/dL |
| Iron | 68 | 64 | 69 | 69 | 69 | 37-170 | mg/dL |
| T3-Uptake | 29.2 | 29.5 | 29.5 | 29.5 | 29.5 | 24.0-38.9% | |
| T4 | 6.6 | 6.3 | 6.4 | 6.5 | 6.5 | 4.7-11.4 | mg/dL |
| TSH | 1.92 | 1.95 | 1.90 | 1.89 | 1.89 | 0.47-6.9 | mU/mL |

Supplements Intakes and PHP Factors (Below)

| | | | | |
|---|---|---|---|---|
| Jan. 1, 2001 | Mar. 1, 2001 | Jun 1, 2001 | Sep. 1, 2001 | Dec 1, 2001 |
| Initial Test Result | Supplement A | Supplement A | Supplement A | Supplement A |
| | | Supplement C | Supplement C | Supplement C |
| Personal Health Profile | Personal Health Profile | Personal Health Profile | Personal Health Profile | Personal Health |
| | | | | Profile |
| Smoker | Stop Smoking | Stop Smoking | Stop Smoking | Stop Smoking |
| Low Fiber Intake | walking 30 m 3x/week | Jogging 30 m 3x/week | Jogging 30 m 3x/week | Jogging 30 m |
| | | | | 3x/week |
| Low Physical Activity | | | Food Diet | Food Diet |

I claim:

1. A method of confidentially providing laboratory results to a consumer of a fluid sample retrieval kit, comprising:
(a) obtaining at least one aliquot of fluid from said consumer of a fluid sample retrieval kit;
(b) selecting a personal identification number by said consumer;
(c) labeling said aliquot of fluid with a unique identification number;
(d) correlating said personal identification number and said unique identification number;
(e) transmitting said at least one aliquot of fluid to a physically remote laboratory for testing;
(f) testing said at least one aliquot of fluid for at least one clinical chemistry to obtain at least one clinical chemistry value;
(g) correlating said at least one clinical chemistry value with said unique identification number; and
(h) electronically providing said at least one clinical chemistry value to said consumer of said fluid sample retrieval kit, in response to receiving said personal identification number.

2. The method of claim 1 wherein said at least one clinical chemistry value is provided to said consumer of said fluid sample retrieval kit via the Internet.

3. The method of claim 1 wherein said fluid sample retrieval kit consists essentially of a tube to receive an aliquot of blood and a container sized to accommodate said tube.

4. The method of claim 1 wherein said at least one aliquot of fluid is selected from the group consisting of: blood and urine.

5. A method to compare clinical chemistry values from consumers of a fluid sample retrieval kit comprising the steps of:
(a) obtaining a plurality of clinical chemistry values from a plurality of consumers of said fluid sample retrieval kit to provide a nutritional supplement database;
(b) scanning said nutritional supplement database for a designated nutritional supplement; and
(c) providing a report on said plurality of clinical chemistry values for said designated nutritional supplement.

6. The method of claim 5 wherein said designated nutritional supplements includes a combination of designated supplements.

7. The method of claim 5 wherein said plurality of clinical chemistry value are selected from the group consisting of: albumin, alkaline phospatase, bilirubin, fluid urea nitrogen, calcium, chloride, cholesterol, creatinine, gamma-glutamyl transaminase, globulin, glucose, HDL cholesterol, lactic dehydrogenase, LDL cholesterol, phosphorous, potassium, sodium, serum glutamic pryurate transaminase, serum glatmic pyruvate transaminase, thyroid panel, triglyceride, hepatitis, HIV and uric acid.

8. A method to provide a plurality of databases comprising:
(a) providing a fluid sample retrieval kit for obtaining at least one aliquot of fluid from a consumer;
(b) testing said at least one aliquot of fluid for at least one clinical chemistry to obtain at least one clinical chemistry value;
(c) obtaining a plurality of clinical chemistry values for more than one consumer to provide a confidential clinical chemistry result database; and
(d) transferring the data from said confidential clinical chemistry result database to a database for designated nutritional supplements.

9. The method of claim 8 wherein said plurality of clinical chemistry values is correlated with said designated nutritional supplements.

10. The method of claim 8 further comprising the steps of:
(e) correlating said at least one clinical chemistry value with a unique identification number;
(f) correlating a personal identification number with said unique identification number; and
(g) providing access to said confidential clinical chemistry result database by a consumer of the fluid sample retrieval system in response to a personal identification number.

11. The method of claim 8 wherein said at least one aliquot of fluid is selected form the group consisting of: blood and urine.

12. The method of claim 8 wherein said designated nutritional supplements includes a combination of designated supplements.

13. The method of claim 8 wherein said fluid sample retrieval kit consists essentially of a tube to receive an aliquot of blood and a container sized to accommodate said tubes.

14. A method to determine the effect of a designated nutritional supplement on a subject comprising the steps of:
(a) providing a plurality of fluid sample retrieval kits for obtaining at least an aliquot of fluid from a subject;
(b) testing said at least one aliquot of fluid for at least one clinical chemistry to obtain at least one clinical chemistry value;
(c) designating at least one nutritional supplement used by said subject;
(d) providing at least one personal health profile factor for said subject;
(e) correlating a plurality of clinical chemistry values from a plurality of subjects; and
(f) correlating a plurality of clinical chemistry values with a designated nutritional supplement to determine the effect of a designated nutritional supplement on a subject.

15. The method of claim 14 including the additional step of correlating a plurality of clinical chemistry values with a designated nutritional supplement and at least one personal health profile factor.

16. The method of claim 14 wherein said at least one personal health profile factor is selected from the group consisting of: social history, medical history and family history.

17. The method of claim 14 wherein said at least one aliquot of fluid is selected from the group consisting of: blood and urine.

18. The method of claim 14 wherein said designated nutritional supplements includes a combination of designated supplements.

19. The method of claim 14 wherein said fluid sample retrieval kit consists essentially of a tube to receive an aliquot of blood and a container sized to accommodate said tubes.

20. The method of claim 14 further comprising charting at least one clinical chemistry value as a function of at least one nutritional supplement used by said subject.

21. A method to compare clinical chemistry values from a plurality of consumers of a fluid sample retrieval kit for at least one designated nutritional supplement;
(a) providing a fluid sample retrieval kit for obtaining at least one aliquot of fluid from a consumer of a fluid sample retrieval kit;
(b) obtaining at least one aliquot of fluid from said consumer;
(c) designating at least one nutritional supplement taken by said consumer;
(d) obtaining a plurality of clinical chemistry values from more than one consumer of said fluid sample retrieval kit to provide a nutritional supplement database;
(e) scanning said database for a designated nutritional supplement; and
(f) providing a report on said plurality of clinical chemistry values for said designated nutritional supplement.

22. The method of claim 21 including the additional step of correlating a plurality of clinical chemistry values with a designated nutritional supplement.

23. The method of claim 21 including the additional step of correlating a plurality of clinical chemistry value with at least one personal health profile factor.

24. The method of claim 21 wherein said fluid sample retrieval kit consists essentially of a fluid transport tube and a container sized to accommodate said tube.

25. The method of claim 21 wherein said plurality of clinical chemistry value are selected from the group consisting of: albumin, alkaline phospatase, bilirubin, fluid urea nitrogen, calcium, chloride, cholesterol, creatinine, gamma-glutamyl transaminase, globulin, glucose, HDL cholesterol, lactic dehydrogenase, LDL cholesterol, phosphorous, potassium, sodium, serum glutamic pryurate transaminase, serum glatmic pyruvate transaminase, thyroid panel, triglyceride, hepatitis, HIV and uric acid.

26. A fluid sample retrieval system comprising:
(a) a fluid sample retrieval kit containing at least one tube to receive an aliquot of bodily fluid;
(b) means to obtain an aliquot of bodily fluids;
(c) means to transmit said aliquot of bodily fluid to a physically remote testing laboratory;
(d) means to designate nutritional supplements consumed by said consumer;
(e) means to detect or determine at least one clinical chemistry value for said aliquot of bodily fluid by said physically remote laboratory;
(f) means to retrievably file at least one of clinical chemistry value correlated with a personal identification number;
(g) means for said consumer of said fluid sample retrieval system to access at least one clinical chemistry value associated with said personal identification number;
(h) means for obtaining personal health profile factors;
(i) means to sort said at least one clinical chemistry value by said designated nutritional supplement; and
(j) means to sort said at least one clinical chemistry value by said personal health profile factors.

27. The system of claim 26 wherein said designated nutritional supplements includes a combination of designated supplements.

28. The system of claim 26 wherein said fluid sample retrieval kit consists essentially of a tube to receive an aliquot of blood and a container sized to accommodate said tubes.
